(19) United States
(12) Patent Application Publication
(10) Pub. No.: US 2026/0099186 A1
(43) Pub. Date: Apr. 9, 2026

(54) SYSTEMS AND METHODS FOR POWER MANAGEMENT

(71) Applicant: Allegro MicroSystems, LLC, Manchester, NH (US)

(72) Inventors: Leandro Tozzi, Buenos Aires (AR); Octavio H. Alpago, Buenos Aires (AR); Francisco Badenas, Buenos Aires (AR); Pablo Córdoba, Buenos Aires (AR)

(73) Assignee: Allegro MicroSystems, LLC, Manchester, NH (US)

(21) Appl. No.: 18/909,224

(22) Filed: Oct. 8, 2024

(51) Int. Cl. G06F 1/3206; G06F 1/10; G06F 1/3237

(52) U.S. Cl. CPC G06F 1/3206; G06F 1/10; G06F 1/3237

(57) ABSTRACT

Disclosed are example systems and methods for power management. In particular, described are example systems and methods that may be used to provide different power modes. For example, different sub-systems that consume different amounts of power may be used in the system. In some embodiments, one of the sub-systems may always be active (i.e., always on (AON)) when the system is powered on, and another of the sub-systems may be switched between being active and being inactive (i.e., powered on and off (ONO)) depending on power mode. In some embodiments, the systems and methods disclosed herein may prevent data sent from an ONO sub-system from being stored in an AON sub-system until the ONO sub-system determines it has been properly reset. In some embodiments, the systems and methods disclosed herein may isolate an AON sub-system from signals sent from an ONO sub-system prior to powering down the ONO sub-system.

### BACKGROUND

Electronic devices are used in a variety of applications. These electronic devices draw power, and managing the power of these devices so that they operate in an efficient manner has become important. For example, portable electronic devices often operate on battery power, such as rechargeable lithium ion batteries. The battery life between charges of these portable electronic devices can be important to users, as they may be away from an outlet and unable to charge a battery for extended periods of time.

As a result, many improvements have been made to extend the battery life of portable electronic devices. Some of these improvements relate to the batteries themselves, such as improvements in the capacity (e.g., number of milliampere-hours (mAh)) of a battery. Other improvements relate to the power efficiency of the circuits or other components in these devices. For example, devices may use power modes to more efficiently utilize the battery. In a normal power mode, such as when a user is actively using the device, circuits and components in the device may draw a significant amount of power from the battery. In a sleep power mode, such as when a device is powered on but not being used, certain portions of a device may remain active, while other portions of the device may be deactivated to save power and preserve battery life.

### SUMMARY

Disclosed are example systems and methods for power management. In particular, described are example systems and methods that may be used to provide different power modes. For example, different sub-systems that consume different amounts of power may be used in a system. In some embodiments, one of the sub-systems may always be active (i.e., always on (AON)) when the system is powered on, and another of the sub-systems may be switched between being active and being inactive (i.e., powered on and off (ONO)) depending on power mode. In some embodiments, an AON sub-system may store power mode configuration information, such that multiple power modes may be supported. In some embodiments, an ONO sub-system may program an AON sub-system with power mode configuration information. In some embodiments, an AON sub-system may operate without its own clock. In some embodiments, an ONO sub-system may have a clock when it is active, and may provide a signal from its clock to an AON sub-system, such that the AON sub-system can use the ONO sub-system's clock when the ONO sub-system is active. In some embodiments, an ONO sub-system may include circuitry to ensure that its clock is stable before a signal from the clock is provided to an AON sub-system. In some embodiments, an AON sub-system may have circuitry configured to prevent stored power mode configuration information from being changed until a clock signal is received from an ONO sub-system. In some embodiments, an AON sub-system may isolate its circuitry from an ONO sub-system when the ONO sub-system is going to be powered down, to prevent erroneous power mode configuration information from being received from the ONO sub-system and being stored in the AON sub-system. Using the systems and methods disclosed herein, a very low power AON sub-system may be provided that may support multiple power modes and that may control one or more ONO sub-systems.

In accordance with some embodiments, there is provided a system. The system comprises a first sub-system comprising a clock generator circuit, a reset monitor circuit, and a gate circuit configured to output a clock signal generated by the clock generator circuit when the reset monitor circuit determines that the first sub-system has successfully reset. The system further comprises a second sub-system comprising storing circuit, wherein the storing circuitry is enabled to store configuration information received from the first sub-system in response to receiving the clock signal from the first sub-system.

In some embodiments, the first sub-system comprises a first voltage domain comprising a first set of circuit components configured to operate at a first voltage and the second sub-system comprises a second voltage domain comprising a second set of circuit components configured to operate at a second voltage different than the first voltage.

In further embodiments, power to the first sub-system is configured to be switched on or off depending on a power mode, and the second sub-system is configured to receive power so long as the system receives power.

In still further embodiments, the first sub-system does not release the clock signal for output to the second sub-system until the reset monitor circuit determines that the first sub-system has successfully reset.

In some embodiments, the reset monitor comprises a plurality of flip flops that are configured to receive a reset signal and to assume a respective default state when the reset signal is set to a predetermined value. The reset monitor further comprises a logic gate coupled to respective output ports of the flip flops and that outputs a signal indicating whether the assumed default state of each of the respective flip flops corresponds to an expected default state for each of the respective flip flops.

In further embodiments, the reset monitor circuit outputs a signal indicating that reset of the first sub-system is successful when the assumed default state of each of the respective flip flops corresponds to the expected default state for each of the respective flip flops.

In still further embodiments, the gate circuit is configured to only output the clock signal to the second sub-system when an output from the reset monitor circuit indicates that reset of the first sub-system has been successful.

In some embodiments, the storing circuitry in the second sub-system is only enabled to store configuration information received from the first sub-system when the storing circuitry receives the clock signal from the first sub-system.

In further embodiments, the second sub-system manages the first sub-system and is programmed by the configuration information received from the first sub-system.

In still further embodiments, the reset monitor and the gate circuit of the first sub-system prevent processing of invalid configuration information sent by the first sub-system when the first sub-system is being powered on from a power off state.

In some embodiments, the second sub-system relies on the clock signal from the first sub-system to store the configuration information from the first sub-system.

In further embodiments, the second sub-system does not have its own dedicated clock generator circuit.

In still further embodiments, the storing circuitry of the second sub-system comprises one or more flip flops.

Furthermore, in accordance with some embodiments, there is provided a method. The method comprises resetting a first sub-system and outputting a clock signal from the first sub-system in response to determining that the resetting of the first sub-system was successful. The method further comprises receiving the clock signal at a second sub-system, and enabling storing circuitry in the second sub-system to store configuration information sent from the first sub-system in response to receiving the clock signal.

In some embodiments, resetting the first sub-system comprises resetting the circuitry of the first sub-system in response to powering on the first sub-system.

Additionally, in accordance with some embodiments, there is provided a system. The system comprises a first sub-system configured to output a clock signal, and a second sub-system. The second sub-system comprises storing circuitry configured to receive the clock signal and store configuration information received from the first sub-system in response to the clock signal. The second sub-system further comprises power mode circuitry configured to receive an instruction to change a power setting and isolate the second sub-system from the clock signal and from further configuration information received from the first sub-system in response to the instruction.

In some embodiments, the first sub-system comprises a first voltage domain comprising a first set of circuit components configured to operate at a first voltage and the second sub-system comprises a second voltage domain comprising a second set of circuit components configured to operate at a second voltage different than the first voltage.

In further embodiments, power to the first sub-system is configured to be switched on or off depending on a power mode, and the second sub-system is configured to receive power so long as the system receives power.

In still further embodiments, the storing circuitry in the second sub-system is only enabled to store the configuration information received from the first sub-system when the storing circuitry receives the clock signal from the first sub-system.

In some embodiments, the second sub-system manages the first sub-system and is programmed by the configuration information received from the first sub-system.

In further embodiments, the second sub-system relies on the clock signal from the first sub-system to store the configuration information from the first sub-system.

In still further embodiments, the second sub-system does not have its own dedicated clock generator circuit.

In some embodiments, the storing circuitry of the second sub-system comprises one or more flip flops.

In further embodiments, in response to the instruction to change the power setting, the power mode circuitry is configured to ensure the configuration information last received from the first sub-system is stored in the storing circuitry, isolate further configuration information sent from the first sub-system to the second sub-system, isolate the clock signal from the second sub-system, and send a power control signal to the first sub-system.

In still further embodiments, the instruction to change the power setting comprises an instruction to power down the first sub-system.

In some embodiments, the power mode circuitry of the second sub-system prevents processing of invalid configuration information sent by the first sub-system when the first sub-system is being powered off from a power on state.

Moreover, in accordance with some embodiments, there is provided a method. The method comprises receiving, by a second sub-system, an instruction to change a power setting, and storing, by the second sub-system, configuration information received from a first sub-system in response to the instruction and in response to a clock signal received from the first sub-system. The method further comprises isolating the first sub-system from the clock signal and from further configuration information received from the first sub-system in response to the instruction, and sending, by the second sub-system, a power control signal to the first sub-system.

In some embodiments, storing the configuration information received from the first sub-system in response to the instruction and in response to the clock signal ensures that the latest reliable configuration information sent form the first sub-system is stored in the second sub-system, and isolating the second sub-system from the clock signal and from the further configuration information received from the first sub-system prevents the second sub-system from receiving an unreliable clock signal and unreliable further information from the first sub-system while the first sub-system powers down.

Before explaining example embodiments consistent with the present disclosure in detail, it is to be understood that the disclosure is not limited in its application to the details of constructions and to the arrangements set forth in the following description or illustrated in the drawings. The disclosure is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings are incorporated in and constitute part of this specification. The drawings, together with the description, illustrate and serve to explain the principles of various example embodiments of the disclosure.

FIG. 1A shows a diagram of an example system for power management, consistent with embodiments of the present disclosure.

FIG. 1B shows a diagram of an example reset process.

FIG. 2A shows a diagram of an example flip-flop.

FIG. 2B shows a diagram of example waveforms illustrating the operation of the example flip-flop of FIG. 2A.

FIG. 2C shows a diagram of another example flip-flop.

FIG. 2D shows a diagram of example waveforms illustrating the operation of the example flip-flop of FIG. 2C.

FIG. 3 shows a diagram of another example system for power management, consistent with embodiments of the present disclosure.

FIG. 4 shows a diagram of an example reset monitor.

FIG. 5 shows a diagram of example waveforms illustrating the operation of the example system of FIG. 3.

FIG. 6 shows a diagram of still another example system for power management, consistent with embodiments of the present disclosure.

FIG. 7 shows a diagram of example waveforms illustrating the operation of the example system of FIG. 6.

FIG. 8 shows a diagram of a further example system for power management, consistent with embodiments of the present disclosure.

FIG. 9 shows a diagram of a still further example system for power management, consistent with embodiments of the present disclosure.

FIG. 10 shows an example process for ensuring that a first sub-system has been successfully reset before enabling the storing of configuration information from the first sub-system in a second sub-system, consistent with embodiments of the present disclosure.

FIG. 11 shows an example process for isolating a second sub-system from a first sub-system prior to powering down the first sub-system.

The drawings are not necessarily to scale, or inclusive of all elements of a system, emphasis instead generally being placed upon illustrating the concepts, structures, and techniques sought to be protected herein.

### DETAILED DESCRIPTION

Reference will now be made in detail to the embodiments of the disclosure, certain examples of which are illustrated in the accompanying drawings.

In the following description, numerous specific details are set forth regarding the systems and methods of the disclosed subject matter, and the environment in which such systems and methods operate, to provide a thorough understanding of the disclosed subject matter. After reading the descriptions provided herein, it will be apparent to one skilled in the art, however, that the disclosed subject matter may be practiced without such specific details. It will also be apparent to one skilled in the art that certain features, which are well known within the art, are not described in detail to avoid unnecessary complication of the description of the systems and methods described herein. In addition, it will be understood that the embodiments provided below are examples, and that it is contemplated that there are other systems and methods that are within the scope of the subject matter disclosed herein.

Systems and methods described herein relate to digital circuitry and logic. A person of ordinary skill in the art would understand certain concepts related to this topic. For example, a person of ordinary skill in the art would understand that a voltage of a signal may be switched between different voltage values, and that these values may represent different logic levels and may be used to represent a binary value of “0 ” or “1.” For example, a voltage value of approximately 0 Volts may correspond to a “0” and a voltage value of a power source (e.g., voltage common collector (VCC)) may correspond to a “1”, or vice versa. A person of ordinary skill in the art would further understand what is meant when referring to digital logic components, such as latches, flip-flops, gates (e.g., AND, OR, NOR, NOT, XOR gates), multiplexers, encoders, decoders, adders, shifters, comparators, registers, counters, shift registers, or any other type of digital logic component.

Disclosed are example systems and methods for power management. In particular, described are example systems and methods that may be used to provide different power modes. For example, different sub-systems that consume different amounts of power may be used in the system. In some embodiments, one of the sub-systems may always be active (i.e., always on (AON)) when the system is powered on, and another of the sub-systems may be switched between being active and being inactive (i.e., powered on and off (ONO)) depending on power mode. In some embodiments, an AON sub-system may store power mode configuration information, such that multiple power modes may be supported. In some embodiments, an ONO sub-system may program an AON sub-system with power mode configuration information. In some embodiments, an AON sub-system may operate without its own clock. In some embodiments, an ONO sub-system may have its own clock when it is active, and may provide a signal from its clock to an AON sub-system, such that the AON sub-system can use the ONO sub-system's clock when the ONO sub-system is active. In some embodiments, an ONO sub-system may include circuitry to ensure that its clock is stable before a signal from the clock is provided to an AON sub-system. In some embodiments, an AON sub-system may have circuitry configured to prevent stored power mode configuration information from being changed until a clock signal is received from an ONO sub-system. In some embodiments, an AON sub-system may isolate its circuitry from an ONO sub-system when the ONO sub-system is going to be powered down, to prevent erroneous power mode configuration information from being received from the ONO sub-system and being stored in the AON sub-system. Using the systems and methods disclosed herein, a very low power AON sub-system may be provided that may support multiple power modes and that may control one or more ONO sub-systems. Systems and methods provided herein may reduce power consumption in a low power mode (e.g., a sleep state), such that the only power consumed is due to leakage power of the active digital logic gates of the AON sub-system during the low power mode.

Utilizing an AON sub-system that does not have its own dedicated clock generator circuit may be advantageous. For example, clocks draw power, and providing an AON sub-system without a clock may allow for very low power modes that may not be possible with AON sub-systems that utilize a clock. However, utilizing an AON sub-system without a clock may present challenges. For example, it may be challenging to synchronize a reset of an ONO sub-system and an AON sub-system when the AON sub-system does not have its own dedicated clock generator circuit. Absent such synchronization, an AON sub-system may receive erroneous data from an ONO sub-system before the ONO sub-system is stable, causing problems in the AON sub-system. Likewise, utilizing an AON sub-system without a clock may make it challenging to isolate the AON sub-system from an ONO sub-system when the ONO sub-system is being powered down. As a result, erroneous data sent from an ONO sub-system during its shut down may be stored in an AON sub-system, causing problems in the AON sub-system. Systems and methods provided herein may address these challenges. That is, utilizing the systems and methods described herein, a very low power AON sub-system may be provided without its own clock. Additionally, utilizing the systems and methods provided herein, it may be ensured that an ONO sub-system is stable before any data sent from the ONO sub-system is stored in an AON sub-system that doesn't have a clock. Moreover, utilizing the systems and methods described herein, it may be ensured that an AON sub-system that doesn't have a clock is isolated from an ONO sub-system before the ONO sub-system begins to power down. Systems and methods disclosed herein may be used to effectively synchronize reset signals between an ONO sub-system and an AON sub-system, thereby preventing invalid configuration of a system. Systems and methods disclosed herein may also be used to isolate an AON sub-system from an ONO sub-system before shutting down the ONO sub-system, without the use of a clock in the AON sub-system. The systems and methods disclosed herein may be used in providing effective power management in very low power applications, and with minimal analog circuit dependencies.

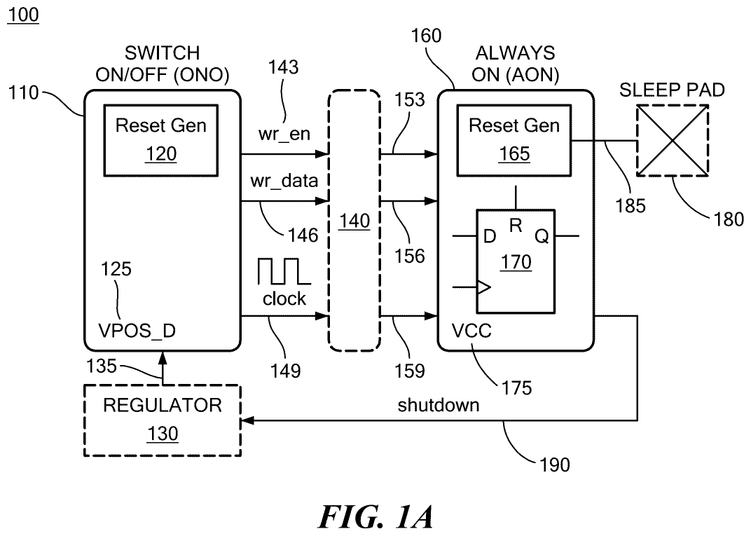

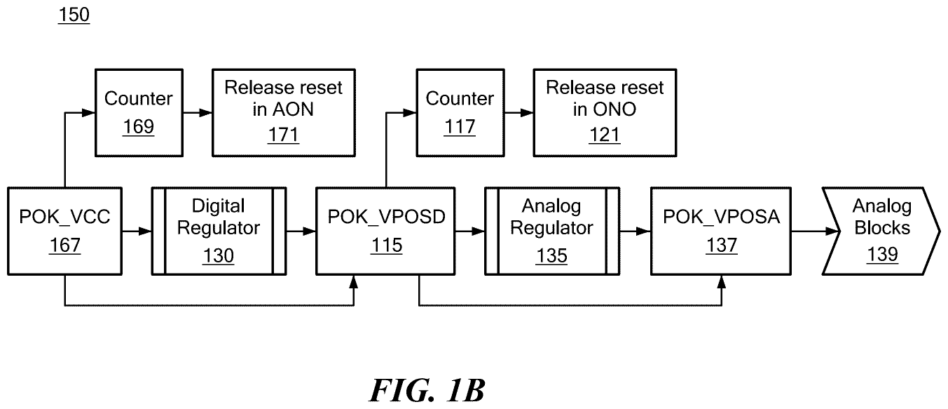

FIG. 1A shows a diagram of an example system 100 for power management, consistent with embodiments of the present disclosure. System 100 may include two sub-systems, a switch on/off (ONO) sub-system 110 and an always on (AON) sub-system 160. Each of the two sub-systems may include circuitry related to one or more functions of system 100. The circuitry in either, or both, of the sub-systems may include digital circuitry, analog circuitry, or a combination of digital and analog circuitry. Digital circuitry may include digital logic components, such as one or more flip flops, latches, gates (e.g., AND, OR, NOT, NAND, XOR), multiplexers, encoders, decoders, adders, shifters, comparators, registers, counters, shift registers, or any other type of digital logic component. Analog circuitry may include analog components, such as oscillators, resistors, capacitors, inductors, diodes, transistors, operational amplifiers, or any other type of analog component.

In some embodiments, ONO sub-system 110 and AON sub-system 160 may operate at different voltages, and may therefore be referred to as being separate “voltage domains.” As one example, AON sub-system 160 may be powered by the power supply of a larger system, and ONO sub-system 110 may be powered at a voltage that is different than the voltage supplied to the larger system. As just one example, AON sub-system 160 may be powered by a 3.3 Volt power supply that powers a larger system, while ONO sub-system 110 may be powered by a 1.8 Volt power supply. However, the disclosure is not so limited. ONO sub-system 110 may be powered by a power supply that provides a voltage that is greater, lower, or equal to the voltage provided to AON sub-system 160.

In the case of example system 100 in FIG. 1A, AON sub-system 160 may be powered by the voltage supply of a larger system, which is represented in FIG. 1A as “VCC” 175 (voltage common collector). Although FIG. 1A shows the supply voltage as VCC 175, one of skill in the art would recognize that metal-oxide-semiconductor field-effect transistors (MOSFETs) may be used in the power circuitry of the larger system instead of bipolar junction transistors (BJTs), in which case the power supply may more properly be referred to as VDD. That is, VCC 175 (as shown in the figures) merely represents supply voltage to AON sub-system 160, and should not be interpreted as limiting the power supply to any particular type of implementation.

In some embodiments, ONO sub-system 110 and AON sub-system 160 may be different sub-systems in an integrated circuit (IC). For example, ONO sub-system 110 and AON sub-system 160 may have different components relating to different functions of the IC. In some embodiments, ONO sub-system 110 and AON sub-system 160 may be different voltage domains of the IC. In one or more low power modes, ONO sub-system 110 may be configured to reduce its power consumption. For example, in at least one low power mode (e.g., sleep mode), ONO sub-system 110 may be powered down and made inactive, while AON sub-system 160 remains active. In another example low power mode, ONO sub-system 110 may remain active, but a frequency of the clock of ONO sub-system 110 may be reduced so as to save power.

As ONO sub-system 110 may operate at a voltage that is different than the voltage used by AON sub-system 160, a voltage regulator 130 may be used to convert the voltage (e.g., VCC 175) supplied from the larger system to the voltage (e.g., VPOS_D 125) used by ONO sub-system 110. In some embodiments, voltage regulator 130 may be considered part of system 100. In other embodiments, voltage regulator 130 may considered to be separate from system 100. As a result, voltage regulator 130 is shown in FIG. 1A in phantom. A person of ordinary skill in the art would recognize that there are many known techniques for converting an input voltage to a desired output voltage, and for regulating that voltage (e.g., to keep it constant). For example, linear regulators and switched-mode power supplies are two example types of power supplies known to convert and regulate a voltage, though the disclosure is not so limited. Any type of known voltage regulator may be used, and should be considered as being within the scope of the disclosure herein.

As ONO sub-system 110 may operate at a different voltage than AON sub-system 160, level shifter and/or isolation circuitry 140 may be used to change a voltage range of one or more signals being communicated between the voltage domains (e.g., from ONO sub-system 110 to AON sub-system 160). Level shifter and/or isolation circuitry 140 may also be used to prevent signals from being sent from one voltage domain to the other voltage domain (e.g., from ONO sub-system 110 to AON sub-system 160) when one of the voltage domains is powering off. A person of ordinary skill in the art would recognize that there are known techniques for implementing voltage level shifting and/or isolation, such as in “isolation cells” used in very-large-scale-integration (VLSI) processes of creating ICs. For example, a person of ordinary skill in the art would recognize that known voltage level shifting techniques may be used in electronics to translate signals from one voltage level to another voltage level, thereby ensuring compatibility between different parts of a circuit. A person of ordinary skill in the art would further recognize that known electrical isolation techniques may be used in electronics to prevent unwanted current flow between certain parts of a circuit and to thereby avoid interference or damage to certain parts of a circuit. Any of these known techniques should be considered to be within the scope of the disclosure herein. In some embodiments, level shifter and/or isolation circuitry 140 may be considered to be part of system 100. In other embodiments, level shifter and/or isolation circuitry 140 may be considered to be separate from system 100. As a result, level shifter and/or isolation circuitry 140 is shown in FIG. 1A in phantom.

As shown in FIG. 1A, ONO sub-system 110 and AON sub-system 160 may each have reset generator circuitry. For example, ONO sub-system 110 may include reset generator circuitry 120, and AON sub-system 160 may include reset generator circuitry 165. Reset generator circuitry 120 and reset generator circuitry 165 may be used to determine when a voltage from a power supply to a respective sub-system is stable. For example, in response to a reset of ONO sub-system 110, reset generator circuitry 120 may determine when the voltage (VPOS_D 125) supplied from voltage regulator 130 is stable. Likewise, in response to a reset of AON sub-system 160, reset generator circuitry 165 may determine when the voltage (VCC 175) supplied from a larger system is stable. As previously discussed, AON sub-system 160 may be configured to always be on so long as a larger system of which it is part is powered on, while ONO sub-system 110 may be configured to be switched on and off while the larger system remains powered on. As such, in some embodiments, a reset of AON sub-system 160 may only occur when a power cycle (e.g., power on, restart) of the larger system occurs. In some embodiments, ONO sub-system 110 may be configured such that signals output from components of ONO sub-system 110 are not relied upon until reset generator circuitry 120 indicates that the voltage (VPOS_D 125) from voltage regulator 130 is stable. AON sub-system 160 may likewise be configured such that signals output from components of AON sub-system 160 are not relied upon until reset generator circuitry 165 indicates that the voltage (VCC 175) from the larger system is stable. A reset generator circuitry (reset generator circuitry 120 or reset generator circuitry 165) may indicate that a voltage is stable by outputting a signal having a digital value, such as a one or a zero.

FIG. 1B shows a diagram 150 of an example reset process that may be implemented by the reset generator circuitry. For example, as shown in FIG. 1B, reset generator circuitry 120 and reset generator circuitry 165 may utilize power OK (POK) modules to determine when the voltage supplied by the power supply to the respective sub-system is stable.

As shown in FIG. 1B, reset generator circuitry 165 may utilize a POK module 167 to determine when the voltage supplied by the power supply (e.g., VCC 175) to AON sub-system 160 is stable. POK module 167 may include analog and/or digital circuitry that determines when a voltage level of the power supply (e.g., VCC 175) exceeds a predefined threshold. For example, POK module 167 may include one or more comparators (or other circuitry that functions similarly to a comparator) that compare the voltage supplied by the power supply to the predetermined threshold. When the voltage supplied by the power supply exceeds the predetermined threshold voltage, a logic high value (e.g., “1”) may be output from reset generator circuitry 165. The logic high value (e.g., “1”) may be output from reset generator circuitry 165 for a predetermined amount of time (e.g., 4 microseconds (μs)) set by counter 169, after which the reset may be released as shown in 171. That is, the logic high value (e.g., “1”) output from reset generator circuitry 165 may change to a logic low value (e.g., “0”) after the predetermined amount of time has elapsed. This process may ensure proper initialization of circuitry in AON sub-system 160.

When POK module 167 determines that the voltage level of the power supply (e.g., VCC 175) exceeds the predefined threshold, regulator 130 may convert and/or regulate the voltage to a voltage level for an ONO sub-system 110 power supply (e.g., VPOS_D 125). Reset generator 120 may utilize a POK module 115 to determine when the voltage supplied (e.g., VPOS_D 125) by regulator 130 to ONO sub-system 110 is stable. POK module 115 may include analog and/or digital circuitry that determines when a voltage level of the voltage supplied (e.g., VPOS_D 125) by regulator 130 to ONO sub-system 110 is stable. For example, POK module 115 may include one or more comparators (or other circuitry that functions similarly to a comparator) that compare the voltage supplied from regulator 130 to the predetermined threshold. When the voltage supplied by regulator 130 exceeds the predetermined threshold voltage, a logic high value (e.g., “1”) may be output from reset generator 120. The logic high value (e.g., “1”) may be output from reset generator circuitry 120 for a predetermined amount of time (e.g., 64 μs) set by counter 117, after which the reset may be released as shown in 121. That is, the logic high value (e.g., “1”) output from reset generator circuitry 120 may change to a logic low value (e.g., “0”) after the predetermined amount of time has elapsed. This process may ensure proper initialization of circuitry in ONO sub-system 110.

A similar process may be performed for any other voltage domains of a system 100. For example, if system 100 includes an analog domain that operates at a different voltage than the voltage supplied to AON sub-system 160 or ONO sub-system 110, such as at an alternating current (AC) voltage, an analog regulator 135 may convert the voltage supplied to the AON sub-system or to the ONO sub-system to an appropriate voltage for the analog domain. A reset generator associated with the analog domain may then utilize a POK module 137 to determine when the voltage supplied by analog regulator 135 is stable, at which point the voltage may be supplied to one or more analog circuitry blocks 139 of the analog domain.

Thus, by leveraging POK modules (e.g., POK module 167, POK module 115, POK module 137) to monitor voltage levels and implement reset generators, a system (e.g., system 100) may ensure that each sub-system (e.g., AON sub-system 160, ONO sub-system 110, analog domain) is properly initialized after its power supply is confirmed to be stable.

Referring again to FIG. 1A, AON sub-system 160 may include storing circuitry 170. The storing circuitry may include one or more registers or one or more flip-flops. Storing circuitry 170 may store configuration information for system 100. For example, storing circuitry 170 may store power mode configuration information. The power mode configuration information may, for example, indicate how AON sub-system 160 should respond to a power state command. For example, AON sub-system 160 may be configured to receive a signal 185 that includes a power state command. The command may be a digital 1 or 0 conveyed by signal 185. Signal 185 may be received from a pin (i.e., sleep pad 180) of another IC or another circuit component. In some embodiments, storing circuitry 170 may store one or more bits indicating the power state that should be entered when a power state command is received. For example, if AON sub-system 160 includes storing circuitry 170 that includes a flip-flop storing one bit, up to four power states may be supported (i.e., two power states (corresponding to a 0 or 1 in the flip-flop) when AON sub-system 160 receives a 0 from sleep pad 180, and two power states (corresponding to a 0 or 1 in the flip-flop) when AON sub-system 160 receives a 1 from sleep pad 180). However, less or more than four power states may be provided. For example, a logic-low level (e.g., “0”) signal from sleep pad 180 may always correspond to an active, normal state, while a logic-high level (e.g., “1”) signal from sleep pad 180 may correspond to a sleep state (where ONO sub-system 110 is made inactive) when storing circuitry 170 is storing a 1, or a low power state when storing circuitry 170 stores a 0. As another example, a logic-low level (e.g., “0”) signal from sleep pad 180 may always correspond to an active, normal state, while a logic-high (e.g., “1”) signal from sleep pad 180 may correspond to a sleep state (where ONO sub-system 110 is inactive) when the flip-flop stores a 1 and the signal from sleep pad 180 may be ignored when the flip-flop stores a zero. Of course, any number of power states may be supported by changing the implementation of the storing circuitry. For example, any number of registers and/or flip-flops may be used to store more information.

In some embodiments, the power mode configuration information may be programmed into storing circuitry 170 of AON sub-system 160 by one or more signals received from ONO sub-system 110. For example, a write enable (wr_en) signal 143 may be transmitted from ONO sub-system 110 when enabling the writing of power mode configuration information into storing circuitry 170, and a write data (wr_data) signal 146 may be transmitted from ONO sub-system 110 including the data for programming the power mode configuration information into storing circuitry 170. For example, a wr_en signal 143 may be a logic-high level (e.g., “1”) when writing of data is enabled, and a logic-low level (e.g., “0”) when writing of data is not enabled, or vice versa. A wr_data signal 146 may be a logic-high level (e.g., “1”) when storing circuitry 170 is to be programmed with a 1, or a logic-low level (e.g., “0”) storing circuitry 170 is to be programmed with a 0. A clock signal 149 may be transmitted from ONO sub-system 110 and used by AON sub-system 160 to write and read data. That is, AON sub-system 160 may operate without its own clock, and may rely on the clock of the ONO sub-system 110 when ONO sub-system 110 is active. Operating AON sub-system 160 without a clock may further reduce the power drawn by AON sub-system 160 when system 100 is in a low power (e.g., sleep) mode. As one example, system 100 may draw less than 30 nanoamps (nA) when operating in a sleep mode (where ONO sub-system 110 is inactive), less than 20 microamps (μA) when operating in a low power (e.g., standby) mode (where ONO sub-system 110 operates at less power than in active mode), and may operate at less than 2.5 milliamps (mA) when operating in an active mode (where ONO sub-system 110 is fully active).

previously discussed, signals 143, 146, and 149 may pass through level shifter and/or isolation circuitry 140, due to the different voltage domains of the two sub-systems. That is, wr_en signal 143 may pass through level shifter and/or isolation circuitry 140 and be output to AON sub-system 160 as signal 153. Wr_data signal(s) 146 may pass through level shifter and/or isolation circuitry 140 and be output to AON sub-system 160 as signal(s) 156. Clock signal 149 may pass through level shifter and/or isolation circuitry 140 and be output to AON sub-system 160 as signal 159.

In some embodiments, when AON sub-system 160 receives a power state command from sleep pad 180 indicating that a power saving state should be entered, and when storing circuitry 170 stores a value (e.g., 1) indicating that a sleep power mode should be entered when that command is received, AON sub-system 160 may send a shutdown command on signal 190 to voltage regulator 130. Voltage regulator 130 may then power down ONO sub-system 110.

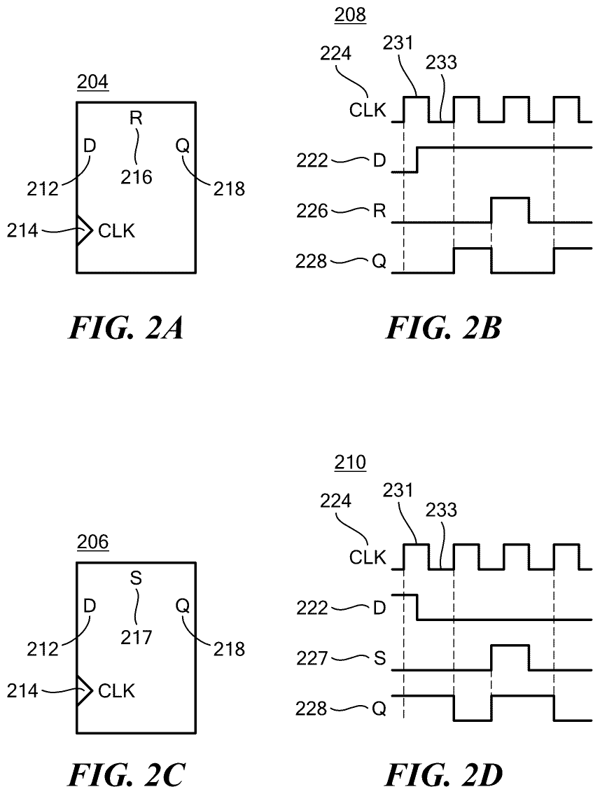

FIG. 2A shows a diagram of an example flip-flop 204 that may be used to implement one or more of the plurality of flip-flops discussed herein, such as one or more of the flip-flops discussed with respect to FIGS. 1, 3, 4, or 6. As shown in FIG. 2A, flip-flop 204 may include a data port D 212, a reset port R 216, an output port Q 218, and a clock port CLK 214 for receiving a clock signal. Flip-flop 204 may be implemented using a D-type flip-flop with a set/reset capability and/or any other suitable type of flip-flop. In this regard, it should be understood that the disclosure is not limited to any particular implementation of flip-flop 204.

FIG. 2B shows a diagram 208 of example waveforms illustrating the operation (and/or configuration) of the example flip-flop of FIG. 2A in further detail. As shown in FIG. 2B, when a signal having a logic-high value (e.g., “1”) is applied at input port D 212 of flip-flop 204, the signal output from output port Q 218 may assume a logic-high value (e.g., “1”) at the next rising edge of the clock signal. When a logic-low value (e.g., “0”) is applied at input port D 212 of flip-flop 204, the signal output from output port Q 218 may assume a logic-low value (e.g., “0”) at the next rising edge of the clock signal. When a signal having a logic-high value (e.g., “1”) is applied at reset port R 216, the signal output from output port Q 218 may asynchronously assume a logic-low value (e.g., “0”). When the signal applied at reset port R 216 then returns to a logic-low value (e.g., “0”), the signal output from output port Q 218 will assume the value at input port D 212 on the subsequent rising edge of the clock signal. Thus, as illustrated in FIG. 2B, the signal output from output port Q 218 may assume a logic high value (e.g., “1”) at the rising edge of the clock cycle following the return of the signal applied at reset port R 216 to a logic-low value (e.g., “0”) (provided that the signal applied at input port D 212 is at a logic-high value (e.g., “1”)). As may be readily appreciated, applying a logic-high (e.g., “1”) signal at reset port R 216 may override any signal that is being applied at input port D 212 of flip-flop 204, and may effectively cause flip-flop 204 to transition into a default state in which flip-flop 204 stores a logic-low value (e.g., “0”). In the example discussed above, flip-flop 204 was reset asynchronously. However, the disclosure is not so limited. A person of ordinary skill in the art would recognize that, in other implementations, flip-flop 204 may be reset synchronously.

FIG. 2C shows a diagram of another flip-flop 206 that may be used to implement one or more of the plurality of flip-flops discussed herein, such as one or more of the flip-flops discussed with respect to FIGS. 1, 3, 4, or 6. As shown in FIG. 2C, flip-flop 206 may include a data port D 212, a set port S 217, an output port Q 218, and a clock port CLK 214 for receiving a clock signal. Flip-flop 206 may be implemented by using a D-type flip-flop with a set/reset capability and/or any other suitable type of flip-flop. In this regard, it should be understood that the disclosure is not limited to any particular implementation of flip-flop 206.

FIG. 2D shows a diagram 210 of example waveforms illustrating the operation (and/or configuration) of the example flip-flop of FIG. 2C in further detail. As shown in FIG. 2D, when a signal having a logic-high value (e.g., “1”) is applied at input port D 212 of flip-flop 206, the signal output from output port Q 218 may assume a logic-high value (e.g., “1”) at the next rising edge of the clock signal. When a signal having a logic-low value (e.g., “0”) is applied at input port D 212, the signal output from output port Q 218 may assume a logic-low value (e.g., “0”) at the next rising edge of the clock signal. When a signal having a logic-high value (e.g., “1”) is applied at set port S 217, the signal output from output port Q 218 may asynchronously assume a logic-high value (e.g., “1”). When the signal applied at set port S 217 then returns to a logic-low value (e.g. “0”), the signal output from output port Q 218 will assume the value at input port D 212 on the subsequent rising edge of the clock signal. Thus, as illustrated in FIG. 2D, the signal output from output port Q 218 may assume a logic low value (e.g., “0”) at the rising edge of the clock cycle following the return of the signal applied at set port S 217 to a logic-low value (e.g., “0”) (provided that the signal applied at port D 212 is at a logic-low value (e.g., “0”) as well). As may be readily appreciated, applying a logic-high (e.g., “1”) signal at set port S 217 may override any signal that is being applied at input port D 212 of flip-flop 206, and may effectively cause flip-flop 206 to transition into a default state in which flip-flop 206 stores a logic-high value (e.g., “1”). In the example discussed above, flip-flop 206 was set asynchronously. However, the disclosure is not so limited. A person of ordinary skill in the art would recognize that, in other implementations, flip-flop 206 may be set synchronously.

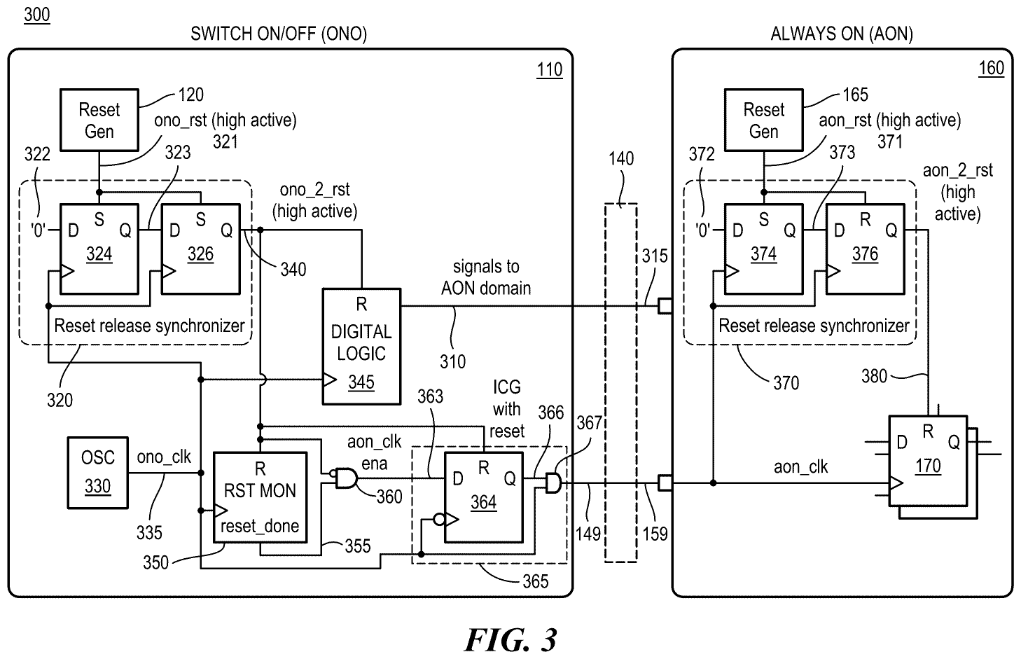

FIG. 3 shows a diagram of another example system 300 for power management, consistent with embodiments of the present disclosure. System 300 may include an ONO sub-system 110, an AON sub-system 160, and level shifter and/or isolation circuitry 140 for level shifting and/or isolating signals communicated between ONO sub-system 110 and AON sub-system 160. In other embodiments, level shifter and/or isolation circuitry 140 may be considered as being separate from system 300, and is therefore shown in phantom in FIG. 3. ONO sub-system 110 of FIG. 3 may be the same as ONO sub-system 110 of FIG. 1A, with FIG. 3 showing additional details of example circuitry and components of AON sub-system 110. AON sub-system 160 of FIG. 3 may be the same as AON sub-system 160 of FIG. 1A, with FIG. 3 showing additional details of example circuitry and components of AON sub-system 160. Level shifter and/or isolation circuitry 140 of FIG. 3 may be the same as level shifter and/or isolation circuitry 140 of FIG. 1A.

As previously discussed with respect to FIG. 1A, ONO sub-system 110 and AON sub-system 160 may each include reset generator circuitry. For example, ONO sub-system 110 may include reset generator circuitry 120 and AON sub-system 160 may include reset generator circuitry 165. As previously discussed with respect to FIG. 1A, reset generator circuitry may determine when a voltage source to a respective sub-system is stable. For example, reset generator circuitry 120 may determine when a voltage (e.g., VPOS_D 125) from a source (e.g., voltage regulator 130) to ONO sub-system 110 is stable, and reset generator circuitry 165 may determine when a voltage (e.g., VCC 175) from a source to AON sub-system 160 is stable. For example, reset generator circuitry 120 and reset generator circuitry 165 may output a logic-high value (e.g., “1”) when the voltage from a source to its respective sub-system is stable.

As shown in FIG. 3, ONO sub-system 110 may include a clock, such as clock generator circuit (e.g., oscillator (osc)) 330. In some embodiments, clock generator circuit 330 may be an analog oscillator. In some embodiments, clock generator circuit 330 may be a digital oscillator based on an analog oscillator. A person of ordinary skill in the art would recognize that there are many known ways to implement a clock, and any of these known techniques should be considered to be within the scope of the disclosure herein. In some embodiments, the clock may toggle between logic-low (e.g., “0”) and logic-high (e.g., “1”) values at a certain frequency. AON sub-system 160 may not include a clock. Instead, ONO sub-system 110 may provide a signal from its clock when ONO sub-system 110 is active, and AON sub-system 160 may utilize that clock signal when ONO sub-system 110 is active. However, in some embodiments, AON sub-system 160 may not utilize any clock signal when ONO sub-system 110 is inactive. Providing AON sub-system 160 without its own clock may allow AON sub-system 160 to draw very little power. Thus, when system 300 is in a low power mode, such as a sleep mode, ONO sub-system 110 may be turned off and AON sub-system 160 kept active, such that system 300 draws very little current (e.g., less than 30 nA).

ONO sub-system 110 and AON sub-system 160 may each include reset release synchronizer circuitry. For example, ONO sub-system 110 may include reset release synchronizer circuitry 320, and AON sub-system 160 may include reset release synchronizer circuitry 370. As shown in FIG. 3, each of the reset release synchronizer circuitries may include two flip-flops connected in series. Each of the flip-flops may include an input port D, an output port Q, a set port S, and a clock (CLK) port. For example, reset release synchronizer 320 of ONO sub-system 110 may include a flip-flop 324 and a flip-flop 326 connected in series. As shown in FIG. 3, output port Q of flip-flop 324 may be connected to input port D of flip-flop 326, such that flip-flop 324 outputs a signal 323 to input port D of flip-flop 326. Flip-flop 324 may receive a signal 322 with a logic-low value (e.g., “0”) at its input port D. Each of flip-flop 324 and flip-flop 326 may receive a signal 321 (shown in FIG. 3 as “ono_rst”) from reset generator circuitry 120 at its set S port. The signal may have a logic-low value (e.g., “0”) or a logic-high value (e.g., “1”). Each of flip-flop 324 and flip-flop 326 may also receive a signal 335 (shown in FIG. 3 as “ono_clk”) from clock (OSC) 330. Signal 335 may be the clock signal of ONO sub-system 110.

Thus, when ONO sub-system 110 is reset, or powered on, reset generator circuitry 120 may output a logic-high value (e.g., “1”) when a voltage from the voltage source that powers ONO sub-system 110 is stable. This logic-high value (e.g., “1”) may be received at the set S ports of flip-flops 324 and 326, causing the output port Q of these flip-flops to asynchronously assume a logic-high value (e.g., “1”). The logic-high value (e.g., “1”) from output port Q of flip-flop 326 may be output as signal 340 (shown in FIG. 3 as “ono_2_rst”), and signal 340 may be used to reset one or more additional components of ONO sub-system 110 (e.g., digital logic circuitry 345 (labeled as “DIGITAL LOGIC” in FIG. 3), reset monitor 350 (labeled as “RST MON” in FIG. 3), flip-flop 364).

Reset generator circuitry 120 may ensure that clock 330 is operating at a stable frequency before a reset state of circuitry in ONO sub-system 110 is released. For example, the counter (e.g., counter 117) for reset generator circuitry 120 may be configured to count for a predetermined amount of time sufficient to ensure that analog circuitry associated with an oscillator has stabilized, that configuration values are set to trim and fine-tune a digital oscillator based on the oscillator, and that the digital oscillator has been aligned with a desired frequency for the clock. That is, the predetermined amount of time counted by the counter (e.g., counter 117) may ensure that clock 330 will have stabilized by the time the reset state is released. In some embodiments, oscillator trim bits may be read, and the predetermined amount of time counted by the counter may be extended to ensure the digital oscillator has sufficient time to stabilize. Thus, when reset generator circuitry 120 releases its reset (i.e., changes signal 321 (ono_rst) from a logic high value (e.g., “1”) to a logic low value (e.g., “0”)), clock 330 is operating at a stable frequency.

When reset generator circuitry 120 changes signal 321 (ono_rst) from a logic high value (e.g., “1”) to a logic low value (e.g., “0”), the logic-low value may then be received by set port S of flip-flop 324 and set port S of flip-flop 326, and the logic-low value “0” on signal 322 may then be passed through flip-flop 324 and flip-flop 326 on rising edges of signal 335 (ono_clk) from clock 330, and output from flip-flop 326 as signal 340 (ono_2_rst). This logic-low value on signal 340 (ono_2_rst) may then cause the one or more additional components of ONO sub-system 110 to release their reset states. For example, digital logic circuitry 345 and reset monitor 350 may release their reset states on the next rising edge of clock signal 335 when signal 340 received at their reset R ports is a logic-low value (e.g., “0”). Flip-flop 364 may release its reset state on the next falling edge of clock signal 335 when signal 340 received at its reset R port is a logic-low value (e.g., “0”).

AON sub-system 160 may include reset release synchronizer circuitry 370, which may operate similarly to reset release synchronizer circuitry 320 of ONO sub-system 110. For example, reset release synchronizer 370 of AON sub-system 160 may include a flip-flop 374 and a flip-flop 376 connected in series. As shown in FIG. 3, output port Q of flip-flop 374 may be connected to input port D of flip-flop 376, such that flip-flop 374 outputs a signal 373 to input port D of flip-flop 376. Flip-flop 374 may receive a signal 372 with a logic-low value (e.g., “0”) at its input port D. Each of flip-flop 374 and flip-flop 376 may receive a signal 371 (shown in FIG. 3 as aon_rst) from reset generator circuitry 165 at its set S port. The signal may have a logic-low value (e.g., “0”) or a logic-high value (e.g., “1”). Each of flip-flop 374 and flip-flop 376 may also receive a signal 159 (shown in FIG. 3 as “aon_clk”). Signal 159 may be the clock signal of AON sub-system 160, which may correspond to the clock signal output by ONO sub-system 110 after having been level shifted by level shifter and/or isolation circuitry 140.

Thus, when AON sub-system 160 is reset, or powered on, reset generator circuitry 165 may output a logic-high value (e.g., “1”) when a voltage from the voltage source that powers AON sub-system 160 is stable. This logic-high value (e.g., “1”) may be received at the set S ports of flip-flops 374 and 376, causing the output port of these flip-flops to asynchronously assume a logic-high value (e.g., “1”). The logic-high value (e.g., “1”) from output port Q of flip-flop 376 may be output as signal 380 (shown in FIG. 3 as “aon_2_rst”), and signal 380 may be used to reset one or more additional components of AON sub-system 160 (e.g., storing circuitry 170).

Reset generator circuitry 165 may output a logic-low value (e.g., “0”) as signal 371 (aon_rst) at a time after outputting the logic-high value (e.g., “1”) as signal 371. For example, reset generator circuitry 165 may change signal 371 (aon_rst) from a logic-high value (e.g., “1”) to a logic-low value (e.g., “0”) after counter 169 determines that a predetermined amount of time (e.g., 4 μs) has elapsed. The logic-low value (e.g., “0”) of signal 371 may then be received by set port S of flip-flop 374 and set port S of flip-flop 376. The clock ports of flip-flops 374, 376, and storing circuitry 170 may all be driven by signal 159 (aon_clk), which is the (voltage-adjusted) clock signal from ONO sub-system 110. As will be further discussed herein, ONO sub-system 110 may be configured such that its clock signal (ono_clk) is not released to AON sub-system 160 until ONO sub-system 110 has determined that its reset has been successful. That is, in order to release the reset condition of signal 380 (aon_2_rst) in AON sub-system 160, two conditions may need to be met (1) signal 371 (aon_rst) may need to be set to a logic-low value (e.g., “0”) (indicating that the reset of AON sub-system 160 has completed), and (2) clock signal 159 (aon_clk) in AON sub-system 160 must be active (indicating that the clock signal has been received from ONO sub-system 110 and that therefore reset of ONO sub-system 110 has completed). When these two conditions have been met, flip-flops 374, 376 may change signal 380 (aon_2_rst) from a logic-high level (e.g. “1”) to a logic-low level (e.g., “0”), thereby releasing the reset state of circuitry in AON sub-system 160. Thus, in doing so, AON sub-system 160 may be prevented from storing any information sent from ONO sub-system 110 until ONO sub-system 110 has determined that its reset has been successful, thereby preventing the storing of any erroneous data from ONO sub-system 110 in AON sub-system 160.

As shown in FIG. 3, ONO sub-system 110 may also include a reset monitor 350 (shown in FIG. 3 as “RST MON”). When signal 340 (ono_2_rst) is set to a predetermined value (e.g., a logic-high value (e.g., “1”)), reset monitor 350 may determine whether ONO sub-system 110 has been reset correctly. Reset monitor 350 may include any suitable type of circuitry configured to detect whether circuitry and/or components of ONO sub-system 110 have been reset correctly based on the predetermined value (e.g., logic-high value (e.g., “1”)) of signal 340 (ono_2_rst). As shown, when it has been determined that the circuitry and/or components of ONO sub-system 110 have been reset correctly, a predetermined value (e.g., a logic-high value (e.g., “1”)) may be output from reset monitor 350 as signal 355. When it has been determined that the circuitry and/or components of ONO sub-system 110 have not been reset correctly, a different predetermined value (e.g., a logic-low value (e.g., “0”)) may be output from reset monitor 350 as signal 355.

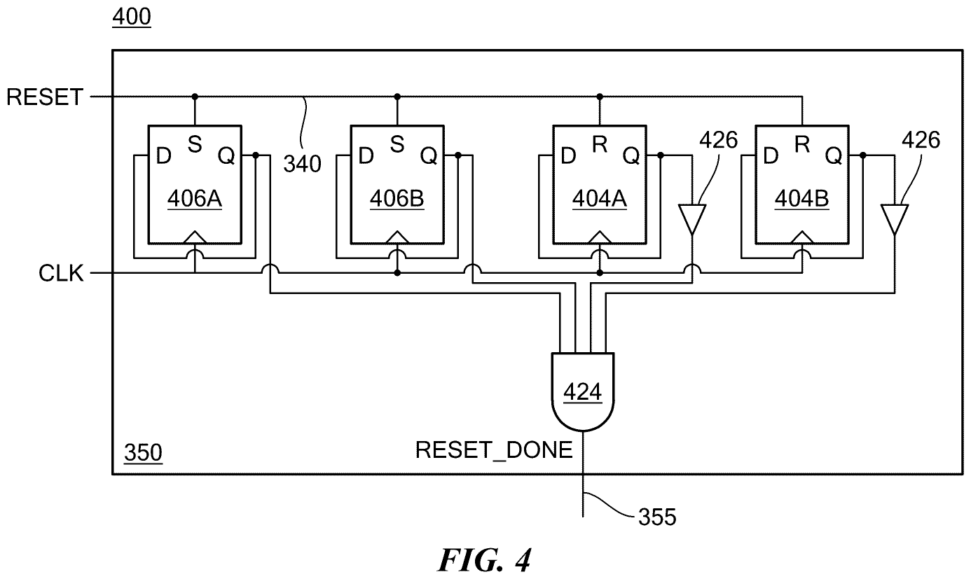

FIG. 4 shows a diagram 400 of one example implementation of reset monitor 350. As shown in FIG. 4, reset monitor 350 may include a plurality of flip-flops 404 (e.g., 404A, 404B) with reset R ports and a plurality of flip-flops 406 (e.g., 406A, 406B) with set S ports. The flip-flops may be coupled in series with one another. A reset R port of flip-flops 404A and 404B may be arranged to receive signal 340 (ono_2_rst), and a set S port of flip-flops 406A and 406B may also be arranged to receive signal 340 (ono_2_rst). When signal 340 is a predetermined value (e.g., a logic-high value (e.g., “1”)), each of flip-flops 404A and 404B may transition into a state (e.g., a first default state) in which it stores a bit value of “0”, and each of flip-flops 406A and 406B may transition into a state (e.g., a second default state) in which it stores a bit value of “1”.

Reset monitor 350 may also include an AND gate 412 and one or more NOT gates 426. AND gate 412 may include a plurality of input ports, where each of the input ports is coupled to an output port Q of a different one of the flip-flops 404A, 404B, 406A, and 406B. As shown in FIG. 4, an output port Q of each of flip-flops 406A and 406B may be coupled to a respective input port of AND gate 424 without using any NOT gates. As further shown in FIG. 4, an output port Q of each of flip-flops 404A and 404B may be coupled to a respective port of AND gate 424 via a respective NOT gate 426. As a result of this arrangement, the signal output from each of flip-flops 406A and 406B may be provided to AND gate 424 without being inverted, whereas the signal output from each of flip-flops 404A and 404B may be inverted before being provided to AND gate 424. Accordingly, when each of flip-flops 404A, 404B, 406A, and 406B is set/reset correctly after receiving signal 340 (ono_2_rst) set to a predetermined value (e.g., a logic-high value (e.g., “1”)), all the inputs to AND gate 424 may be 1s, and AND gate 424 may output a RESET_DONE signal of a predetermined value (e.g., a logic-high value (e.g., “1”)) as signal 355. By contrast, when one or more of flip-flops 404A, 404B, 406A, and 406B is not set/reset correctly, (e.g., due to a fault), one or more of the inputs to AND gate 424 may be a 0, and AND gate 424 may output a RESET_DONE signal of another predetermined value (e.g., a logic-low value (e.g., “0”)) as signal 355.

As shown in FIG. 4, an output Q port of each of flip-flops 404A, 404B, 406A, and 406B may be coupled to that flip-flop's respective input D port via a respective feedback line. In this regard, in the example of FIG. 4, reset monitor 350 may be essentially arranged to operate as a read-only memory that is hardwired to store a predetermined bit string. As may be readily appreciated, the value of the bit string may be determined by the order in which flip-flops 404A, 404B, 406A, and 406B are arranged. In the example of FIG. 4, this value is “1100.” In this regard, signal 340 (ono_2_rst), when set to a predetermined value (e.g., a logic-high value (e.g., “1”)), may cause reset monitor 350 to assume a state in which the default bit string is stored in reset monitor 350. Moreover, when signal 340 (ono_2_rst) then returns to another predetermined value (e.g., a logic-low value (e.g., “0”)), the inputs to AND gate 424 may continue to be 1s and the output of reset monitor 350 may continue to be a logic-high level (e.g., “1”), as a result of the output port Q of each flip-flop being tied to the input port D of the respective flip-flop. Because with time the state of each of flip-flops 404A, 404B, 406A, and 406B may drift, it may be necessary to occasionally reset flip-flops 404A, 404B, 406A, and 406B to ensure that the (correct) bit string remains stored in reset monitor 350. It should be understood that reset monitor 350 may be configured to store other bit strings (instead of or in addition to the default bit string), which may be loaded into the flip-flops via the respective input D ports of the flip-flops. In this regard, it should be understood that the present disclosure should not be limited to any specific topology for wiring the input D ports (and/or output Q ports) of the flip-flops.

FIG. 4 is provided as an example only. In this regard, it should be understood that the present disclosure is not limited to any particular configuration of reset monitor 350. For example, in some implementations, AND gate 424 may be implemented as a network of AND gates. Additionally, or alternatively, in some implementations, NOT gates 426 may be integrated into AND gate 424 to form an AND gate with inverted inputs. Although FIG. 4 depicts reset monitor 350 as having two flip-flops with set S ports and two flip-flops with reset R ports in a particular order, the disclosure is not so limited. For example, in some implementations a different ordering of flip-flops may be used.

Example reset monitor 350 of FIG. 4 includes two flip-flops 404 with reset R ports, and two flip-flops 406 with set S ports. However, the disclosure is not so limited. For example, alternative implementations of reset monitor 350 are possible that include any number of flip-flops with reset R ports, or no flip-flops with reset R ports at all. Likewise, implementations of reset monitor 350 are possible that include any number of flip-flops with set S ports, or no flip-flops with set S ports at all. In this regard, it should be understood that the present disclosure is not limited to implementing reset monitor 350 with any specific type and/or number of flip-flops.

Returning to FIG. 3, signal 355 output from reset monitor 350 may be input to an AND gate 360. Another input of AND gate 360 may be configured as an inverting input, and may receive signal 340 (ono_2_rst). When signal 340 (ono_2_rst) returns from a logic-high value (e.g., “1”) to a logic-low value (e.g., “0”) and thereby releases the reset state of the components in ONO sub-system 110, the logic-low value may be inverted at the inverting input of AND gate 360, and AND gate 360 may therefore output a logic-high value (e.g., “1”) as signal 363 (labelled as AON clock enable or “aon_clk_ena” in FIG. 3). Signal 363 (aon_clk_ena) may be received at an input port D of a flip-flop 364 in integrated clock gating (ICG) circuitry 365. Flip-flop 364 may have a clock (CLK) port with an inverting input that receives the clock signal, signal 335 (ono_clk). Thus, when signal 340 transitions from a logic-high value (e.g., “1”) to a logic-low value (e.g., “0”), thereby releasing the reset state of the components in ONO sub-system 110, and when signal 363 (aon_clk_ena) is a logic-high value (e.g., “1”), and when a falling edge of signal 335 (ono_clk) is received at flip-flop 364, output port Q of flip-flop 364 may output a logic-high value (e.g., “1”) as signal 366. Signal 366 may be received at an input port of an AND gate 367 of ICG circuitry 365. Another input of AND gate 367 may be coupled to the clock signal, signal 335 (ono_clk). Thus, as the clock signal toggles between a logic-low value (e.g., “0”) and a logic-high value (e.g., “1”), the clock signal may be output as signal 149 to level shifter and/or isolation circuitry 140. In other words, the clock signal from ONO sub-system 110 may be released to AON sub-system 160 for use by AON sub-system 160. As previously discussed, level shifter and/or isolation circuitry 140 may then convert the voltage range of the clock signal 149 to an appropriate voltage range for AON sub-system 160 and output the clock signal as clock signal 159 (referred to as “aon_clk” in FIG. 3).

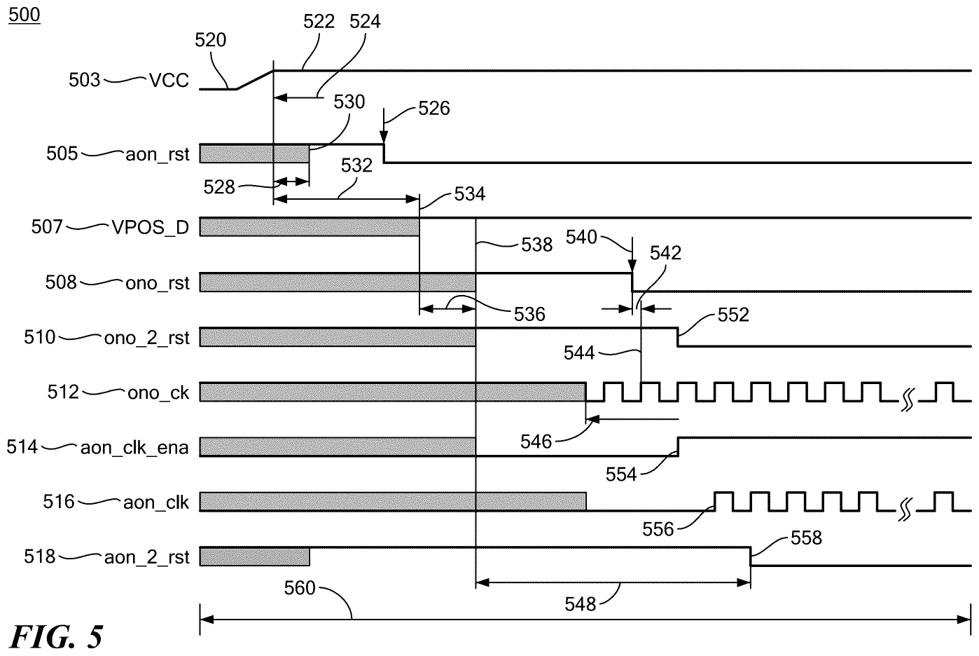

Once the clock signal has been released from ONO sub-system 110 and received by AON sub-system 160 as signal 159 (aon_clk), flip-flops 374 and 376 may receive signal 159 at their clock (CLK) ports, causing the value “0” to pass through flip-flops 374 and 376 and to be output as signal 380 (referred to as “aon_2_rst” in FIG. 3), thereby releasing the reset state of storing circuitry 170. As a result, data output from digital logic circuitry 345 in ONO sub-system 110 as signal 310, and input to AON sub-system 160 as signal 315 after having been level shifted by level shifter and/or isolation circuitry 140, may be received at an input port D of storing circuitry 170 and stored in storing circuitry 170. This data may be, for example, power mode configuration information sent from ONO sub-system 110 for storage into storing circuitry 170 of AON sub-system 160. This power mode configuration information may program AON sub-system 160 to control a power state of ONO sub-system 110 in a particular way when a power state command is received from the sleep pad. 94 FIG. 5 shows a diagram 500 of example waveforms (e.g., waveforms 503, 505, 507, 508, 510, 512, 514, 516, 518) illustrating the operation (and/or configuration) of the example system of FIG. 3 in further detail. An X-axis 560 for each of the waveforms represents time, and a Y-axis (perpendicular to the X-axis) for each of the waveforms represents a voltage level.

503 is an example waveform of a voltage (e.g., VCC 175) for the overall system. For example, upon powering on the system, a voltage VCC 175 may ramp from 0 Volts 520 to a stable “on” voltage 522 (e.g., 3.3V). 524 represents a time at which VCC becomes stable.

505 is an example waveform of a voltage of signal 371 (aon_rst). The grey portion of the waveform represents an amount of time during what the value of signal 371 (aon_rst) may be unpredictable as a result of the ramp up of VCC. 530 represents a time at which reset generator circuitry 165 determines that the power to AON (e.g., VCC 175) is stable. 528 represents an amount of time between a time 524 when VCC 175 becomes stable and a time 530 at which reset generator circuitry 165 determines that VCC 175 is stable. Time 528 may be a random amount of time or a defined amount of time depending on the implementation of reset generator circuitry 165. 526 represents a time at which signal 371 (aon_rst) transitions from a logic-high value (e.g., “1”) to a logic-low value (e.g., “0”). Signal 371 may make this transition at time 526 without releasing the reset state of components in AON sub-system 160, because ONO sub-system 110 has not yet released its clock signal to AON sub-system 160, thereby preventing flip flops 374, 376 from releasing the reset state.

518 is an example waveform of a voltage of signal 380 (aon_2_rst). The grey portion of the waveform represents an amount of time during which the value of signal 380 (aon_2_rst) may be unpredictable. As shown in FIG. 5, once reset generator circuitry 165 determines that the power to AON (e.g., VCC 175) is stable and outputs signal 371 (aon_rst) at a logic-high value (e.g., “1”), flip-flops 374, 376 may output a value of “1” from output port Q of flip-flop 376 as signal 380 (aon_2_rst).

507 is an example waveform of a voltage (e.g., VPOS_D 125) for powering ONO sub-system 110. As previously discussed, the voltage supplied to ONO sub-system 110 may be different than the voltage supplied to AON sub-system 160. As previously discussed, in some embodiments the voltage provided to AON sub-system 160 (e.g., VCC 175) may also be provided to a voltage regulator 130, which may convert the voltage to voltage VPOS_D 125 for powering ONO sub-system 110. Voltage regulator 130 may then provide voltage VPOS_D 125 to ONO sub-system 110 over signal 135. The grey portion of waveform 507 represents an amount of time during which the value of VPOS_D 125 is unpredictable (e.g., due to time to ramp up VCC 175 and then to convert VCC 175 to a stable voltage VPOS_D 125). 534 represents a time at which voltage VPOS_D 125 becomes stable. 532 represents an amount of time between a time 524 when voltage VCC 175 becomes stable and time 534 when voltage VPOS_D 125 becomes stable.

508 is an example waveform of a voltage of signal 321 (ono_rst). The grey portion of the waveform represents an amount of time during which the value of signal 321 (ono_rst) may be unpredictable (e.g., as a result of voltage VPOS_D 125 still not being stable). 538 represents a time at which reset generator circuitry 120 determines that the voltage supply (e.g., VPOS_D 125) to ONO sub-system 110 is stable. 536 represents an amount of time between a time 534 when voltage VPOS_D 125 becomes stable and a time 538 at which reset generator circuitry 120 determines that voltage VPOS_D 125 is stable. Time 536 may be a random amount of time or a defined amount of time depending on the implementation of reset generator circuitry 120. When reset generator circuitry 120 determines that voltage VPOS_D 125 is stable, reset generator circuitry 120 may output signal 321 (ono_rst) as a logic-high value (e.g., “1”).

510 is an example waveform of a voltage of signal 340 (ono_2_rst). The grey portion of the waveform represents an amount of time during which the value of signal 340 (ono_2_rst) may be unpredictable. As shown in FIG. 5, once reset generator circuitry 120 determines that the voltage (e.g., VPOS_D) to ONO sub-system 110 is stable and outputs signal 321 (ono_rst) at a logic-high value (e.g., “1”), flip flops 324, 326 may output a value of “1” from output port Q of flip flop 326 as signal 340 (ono_2_rst) at time 538.

512 is an example waveform of a voltage of the clock signal, signal 335 (ono_clk) of ONO sub-system 110. The grey portion of waveform 512 represents an amount of time during which the value of signal 335 (ono_clk) may be unpredictable. Time 546 represents a time at which signal 335 (ono_clk) becomes stable. As shown in FIG. 5, once stable, signal 335 (ono_clk) toggles between logic-high (e.g., “1”) and logic-low (e.g., “0”) values at a predetermined frequency.

As shown in waveform 508, signal 321 (ono_rst) may be transitioned from a logic-high level (e.g., “1”) to a logic-low level (e.g., “0”) when the clock signal, signal 335 (ono_clk), is stable. For example, as previously discussed, in some embodiments a counter (e.g., counter 117) may be configured to count for a predetermined amount of time sufficient to ensure that analog circuitry associated with an oscillator has stabilized, that configuration values are set to trim and fine-tune a digital oscillator based on the oscillator, and that the digital oscillator has been aligned with a desired frequency for the clock. That is, the predetermined amount of time counted by the counter (e.g., counter 117) may ensure that clock 330 will have stabilized by the time the reset state is released. In some embodiments, oscillator trim bits may be read, and the predetermined amount of time counted by the counter may be extended to ensure the digital oscillator has sufficient time to stabilize. 540 represents a time when signal 321 (ono_rst) is transitioned from a logic-high level (e.g., “1”) to a logic-low level (e.g., “0”). 542 represents an amount of time between time 540 and a time 544 of a rising edge of the clock signal, signal 335 (ono_clk). As shown by the misalignment between time 540 and time 544, there may be no phase relationship between when signal 321 (ono_rst) transitions to a logic-low level (e.g., “0”) and the clock signal.

As shown in waveform 510, signal 340 (ono_2_rst) may be transitioned from a logic-high level (e.g., “1”) to a logic-low level (e.g., “0”) after signal 321 (ono_rst) has been transitioned from a logic-high level (e.g., “1”) to a logic-low level (e.g., “0”). As shown in FIG. 5, this transition for signal 340 (ono_2_rst) may occur on the second rising edge of the clock signal, signal 335 (ono_clk), after signal 321 (ono_rst) has transitioned to a logic-low level (e.g., “0”). That is, the first rising edge of clock signal 335 after signal 321 (ono_rst) has transitioned to a logic-low level (e.g., “0”) may cause the Q output port of flip-flop 324 to be at a logic-low level (e.g., “0”), which will be input to the D input port of flip-flop 326. The second rising edge of clock signal 335 after signal 321 (ono_rst) has transitioned to a logic-low value (e.g., “0”) may cause the Q output port of flip-flop 326 to be a logic-low level (e.g., “0”), thereby making signal 340 (ono_2_rst) a logic-low level (e.g., “0”). The transition of signal 340 from a logic-high level (e.g., “1”) to a logic-low level (e.g., “0”) may cause the reset of other components in ONO sub-system 110 to be released.

514 is an example waveform of a voltage of signal 363 (aon_clk_ena) of ONO sub-system 110. The grey portion of waveform 514 represents an amount of time during which the value of signal 363 (aon_clk_ena) may be unpredictable. Signal 363 (aon_clk_ena) may be transitioned from a logic-low level (e.g., “0”) to a logic-high level (e.g., “1”) when signal 340 (ono_2_rst) has been transitioned to a logic-low level (e.g., “0”), thereby releasing the release state of components in ONO sub-system 110, and when reset monitor 355 has determined that ONO sub-system 110 has been properly reset (as previously discussed). That is, AND gate 360 may receive the logic-low value (e.g., “0”) of signal 340 (ono_2_rst) at an inverting input when the reset state has been released, and may receive a logic-high value (e.g., “1”) of signal 355 from reset monitor 350 when reset monitor 350 has determined that ONO sub-system 110 has been properly reset. AND gate 360 may then output a logic-high (e.g., “1”) value as signal 363 (aon_clk_ena), which is shown in FIG. 5 as occurring at a time 554 (at approximately the same time as signal 340 (ono_2_rst) transitions from a logic-high level (e.g., “1”) to a logic-low level (e.g., “0”)).

516 is an example waveform of a voltage of signal 159 (aon_clk) of AON sub-system 160. The grey portion of waveform 516 represents an amount of time during which the value of signal 159 (aon_clk) may be unpredictable. As shown in FIG. 5, signal 159 (aon_clk) of AON sub-system may begin to toggle between a logic-low value (e.g., “0”) and a logic-high value (e.g., “1”) after signal 363 (aon_clk_ena) has transitioned from a logic-low level (e.g., “0”) to a logic-high value (e.g., “1”). As shown in FIG. 3, flip-flop 364 in integrated clock gating (ICG) circuitry 365 may be released from a reset state when signal 340 (ono_2_rst) transitions from a logic-high level (e.g., “1”) to a logic-low level (e.g., “0”). Then, when flip-flop 364 receives a logic-high level (e.g., “1”) from signal 363 (aon_clk_ena) at its input D port, and a falling edge of the clock signal, signal 335 (ono_clk), at its inverting clock input port, flip-flop 364 may output a logic-level high signal (e.g., “1”) from its output Q port as signal 366. Signal 366 may be received by an input port of AND gate 367 in ICG circuitry 365. Another input of AND gate 367 may be connected to the clock signal, signal 335 (ono_clk). An output signal 149 of AND gate 367 may then toggle between a logic-low level (e.g., “0”) and a logic-high level (e.g., “1”) in accordance with the toggling of the clock signal. As a result, output signal 149 of AND gate 367 may correspond to, and be substantially the same as, the clock signal, signal 335 (ono_clk). As previously discussed, level shifter and/or isolation circuitry 140 may adjust the voltage range of signal 149 to be compatible with the voltage domain of AON sub-system 160, and may output the adjusted signal as 159 (aon_clk). Signal 159 may then be used as the clock of AON sub-system 160 (so long as ONO sub-system 110 outputs its clock (e.g., so long as ONO sub-system 110 remains in an active state)). FIG. 5 shows that signal 159 (aon_clk) may begin toggling at a time 556, which may correspond to the first rising edge of the clock signal from ONO sub-system 110, signal 335 (ono_clk), after signal 363 (aon_clk_ena) transitions from a logic-low level (e.g., “0”) to a logic-high level (e.g., “1”).

518 is an example waveform of a voltage of signal 380 (aon_2_rst). As shown in FIG. 5, signal 380 (aon_2_rst) may be transitioned from a logic-high level (e.g., “1”) to a logic-low level (e.g., “0”) once signal 159 (aon_clk) is being received by flip-flops 374, 376 of reset release synchronizer 370 in AON sub-system 160. Transition of signal 380 (aon_2_rst) from a logic-high level (e.g., “1”) to a logic-low level (e.g., “0”) may release a reset state of components in AON sub-system 160, such as storing circuitry 170. Storing circuitry 170 may then store data, such as power mode configuration information, received in signal(s) 310, 315 from digital logic circuitry 345 of ONO sub-system 110. For example, storing circuitry 170 may store data received in signal(s) 310, 315 at input port(s) D when rising edges of signal 159 (aon_clk) are received at the clock port of storing circuitry 170.

Thus, as discussed above, after ONO sub-system 110 has been reset (e.g., restarted, powered on), or after both ONO sub-system 110 and AON sub-system 160 have been reset (e.g., restarted, powered on), AON sub-system 160 may be prevented from storing data received from ONO sub-system 110, such as power mode configuration information, until ONO sub-system 110 has determined it has been properly reset and releases its clock (ono_clk) to AON sub-system 160 (as aon_clk).

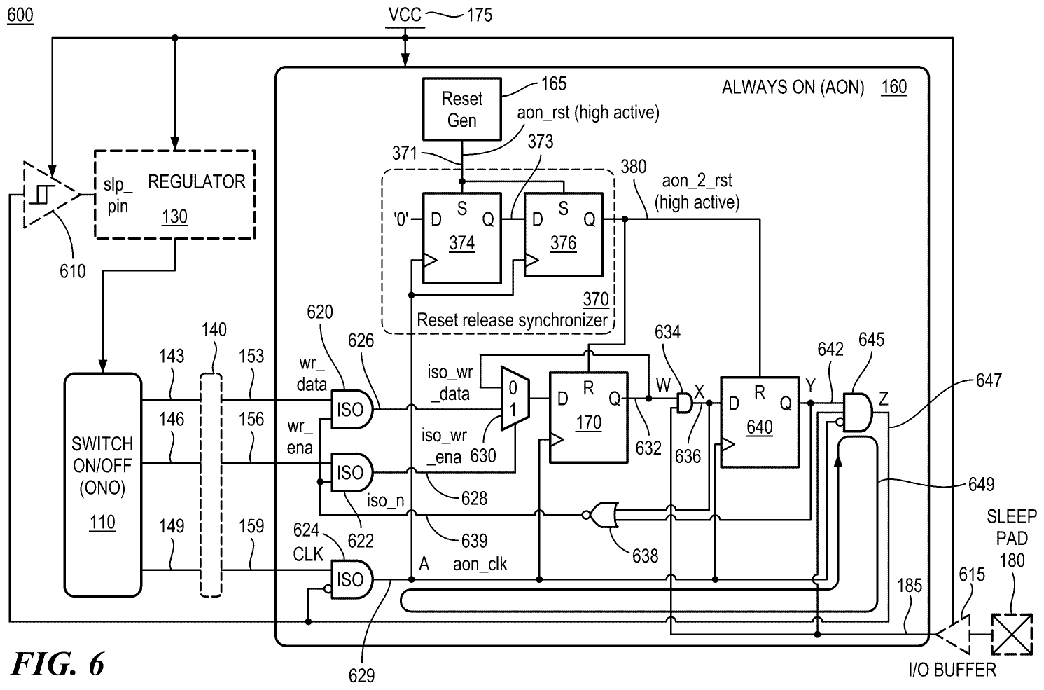

FIG. 6 shows a diagram of still another example system 600 for power management, consistent with embodiments of the present disclosure. System 600 may by the same system as system 300 of FIG. 3, with additional and/or different details shown. System 600 may include an ONO sub-system 110, an AON sub-system 160, level shifter and/or isolation circuitry 140 for level shifting and/or isolating signals communicated between ONO sub-system 110 and AON sub-system 160, a buffer 615 (e.g., input/output (I/O) buffer), a buffer 610, and a voltage regulator 130. A sleep pad 180 may not be a part of system 600, and is therefore shown in phantom. In some embodiments, one or more of level shifter and/or isolation circuitry 140, buffer 615, buffer 610, and regulator 130 may not be considered to be part of system 600. As a result, these elements are also shown in phantom.

System 600 may be used to isolate AON sub-system 160 from ONO sub-system 110 when a power state command has been received from a sleep pad (e.g., sleep pad 180) indicating that ONO sub-system 110 is to be powered down (e.g., to enter a sleep power mode). During the powering down of ONO sub-system 110, signals received from ONO sub-system 110 may be unpredictable. Thus, by isolating AON sub-system 160 from ONO sub-system 110 before ONO sub-system 110 begins to be powered down, AON sub-system 160 may be prevented from storing erroneous data sent from ONO sub-system 110.

As previously discussed with respect to FIGS. 3 and 5, AON sub-system 160 may include reset generator circuitry 165 and a reset release synchronizer 370. Reset release synchronizer 370 may include two flip-flops 374, 376, coupled in series (e.g., output Q port of flip-flop 374 coupled to input D port of flip-flop 376). As previously discussed, reset generator circuitry 165 may output a signal 371 with a logic-low (e.g., “0”) or logic-high (e.g., “1”) value to the set S ports of flip-flops 374, 376. When signal 371 is a logic-high (e.g., “1”) value, a signal 380 (aon_2_rst) may reset components within AON sub-system 160, such as storing circuitry 170 (previously discussed) and storing circuitry 640 (e.g., flip-flop, register) (which will be further discussed below). As previously discussed, after reset generator circuitry 165 returns to a logic-low (e.g., “0”) level, and after the clock signal from ONO sub-system 110 is released and received by AON sub-system 160 as signal 159, the value “0” may be passed through flip-flops 374, 376, causing signal 380 (aon_2_rst) to be a logic-low value (e.g., “0”), thereby releasing a reset state of the components in AON sub-system 160. Although not shown in the example in FIG. 3, in system 600 of FIG. 6 an AND gate 624 is shown as being used as isolation circuitry to isolate signal 159 (previously described with respect to FIGS. 3 and 5 as aon_clk) from AON sub-system 160. In system 600, the output of AND gate 624 is labeled as signal 629 (aon_clk), which is the clock for AON sub-system 160 after having passed through isolation AND gate 624.

When ONO sub-system 110 has been properly reset, is active, and has its clock released to AON sub-system 160, and when AON sub-system 160 has released the reset state of its components and is receiving signal 629 (aon_clk), storing circuitry 170 may receive and store configuration information, such as power mode configuration information, from ONO sub-system 110. For example, as previously discussed, AON sub-system 160 may then receive a logic-high (e.g., “1”) value on signal 156 (wr_ena) and one or more values (e.g., 1s or 0s) on signal(s) 153, allowing the value(s) on signal(s) 153 to be stored in storing circuitry 170 as power mode configuration information. A multiplexer 630 may be used to determine whether signal 628 (isolated write enable (iso_wr_ena)) is at a logic-high (e.g., “1”) value. Multiplexer 630 may receive signal 628, signal 626 (isolated write data (iso_wr_data)), and signal 632 (labelled as “W” in FIG. 6) from the output of storing circuitry 170. When signal 628 (iso_wr_ena) is at a logic-high (e.g., “1”) value, signal 626 (iso_wr_data) may be output from multiplexer 630 to input port D of storing circuitry 170, thereby allowing the power mode configuration information from ONO sub-system 110 to be stored in storing circuitry 170. When signal 628 (iso_wr_ena) is at a logic-low (e.g., “0”) value, signal 632 (“W”) may be output from multiplexer 630, such that the value of the power mode configuration information in storing circuitry 170 stays the same.

Storing circuitry 170 may be programmed with a logic-low (e.g., “0”) or logic-high (e.g., “1”) value by ONO sub-system 110 depending on a desired power mode action to be taken when a power state command is received from sleep pad 180. For example, ONO sub-system 110 may program storing circuitry 170 with power mode configuration information including a logic-high (e.g., “1”) value when it is desired to cause a shutdown of ONO sub-system 110 upon receiving a power state command (e.g., “1”) from sleep pad 180, and with a logic-low (e.g., “0”) value when it is not desired to cause a shutdown of ONO sub-system 110 upon receiving a power state command (e.g., “1”) from sleep pad 180 (e.g., to instead reduce a frequency of the clock of ONO sub-system 110, perform some other low power mode function, or otherwise do nothing). When a power state command is received on signal 185 from sleep pad 180 (e.g., through an input/output buffer 615), the value of that command may be input to an AND gate 634. AND gate 634 may include another input coupled to a signal 632 (“W”) output from the output port Q of a storing circuitry 170. Then, when AND gate 634 receives a power state command with a logic-high (e.g., “1”) value from sleep pad 180 on signal 185 and a logic-high (e.g., “1”) value on signal 632 (W) from output port Q of storing circuitry 170 (e.g., due to the value “1” having been stored as power mode configuration information in storing circuitry 170), AND gate 634 may output a logic-high (e.g., “1”) value as signal 636 (labelled as “X” in FIG. 6).

Signal 636 (“X”) may be input to an input port D of storing circuitry 640, and also input to a NOR gate 638. With signal 380 (aon_2_rst) at a logic-low value (e.g., “0”), the value of signal 636 may be stored in storing circuitry 640 on the next rising edge of signal 629 (aon_clk). Storing the value of signal 636, which conveys the last power mode configuration state before shutting down ONO sub-system 110, into storing circuitry 640 may help to achieve independence from input signals, regardless of whether the input signals are isolated or not. That is, storing this value in storing circuitry 640 may ensure that the shutdown sequence is based on a stable and accurately recorded state of ONO sub-system 110, thereby preventing any discrepancies that might arise from fluctuating input signals. Thus, storing the last power mode configuration information before ONO sub-system 110 is powered down in storing circuitry 640 may enhance the robustness of the shutdown process, ensuring that the transition of ONO sub-system 110 to an inactive state is both reliable and consistent.

The value of signal 636, when stored in storing circuitry 640, may also be output at output port Q as signal 642 (labeled as “Y” in FIG. 6). Signal 642 (“Y”) may be input to another input port of NOR gate 638. Thus, when either or both of signals 636 (“X”) and signal 642 (“Y”) is at a logic-high level (e.g., “1”) signal, NOR gate 638 will output a signal 639 at a logic-low (e.g., “0”) value. Signal 639 may be input to AND gates 620 and 622, which act as isolation gates for signal 156 (wr_ena) and signal(s) 153 (wr_data) from ONO sub-system 110. Thus, when signal 636 (“X”) or signal 642 (“Y”) is a logic-high (e.g., “1”) value (indicating that ONO sub-system 110 is to be shut down), AON sub-system 160 may be isolated from signals 153, 156 by the isolation AND gates 620, 622.

Signal 642 (“Y”) may also be input to an AND gate 645. AND gate 645 may have another input coupled to signal 185 (e.g., the power state command signal from sleep pad 180 after having passed through optional I/O buffer 615). AND gate 645 may have an inverting input coupled to signal 629 (aon_clk). Thus, when signal 642 (“Y”) is at a logic-high level (e.g., “1”) (indicating that ONO sub-system 110 is going to be shut down and that a logic-low level (e.g., “0”) is being output from NOR gate 638 and that therefore isolation AND gates 620, 622 are isolating AON sub-system 160 from ONO sub-system 110), and when signal 185 indicates that the sleep pad is inputting a logic-high level (e.g., “1”) (e.g., a sleep command), then when a falling edge of signal 629 (aon_clk) is received by AND gate 645, AND gate 645 may output a signal 647 (labeled as “Z” in FIG. 6) that is at a logic-high level (e.g., “1”). Signal 647 (“Z”) may be coupled to an inverting input of isolation AND gate 624, such that a logic-high value (e.g., “1”) of signal 647 causes the clock from ONO sub-system 110 to be isolated from AON sub-system 160. Signal 647 may also be coupled to a buffer 610 and then to an input (sleep pin (slp_pin)) of voltage regulator 130, and the logic-high level (e.g., “1”) of signal 647 may cause voltage regulator 130 to power down ONO sub-system 110. Thus, system 600 operates to isolate AON sub-system 160 from signals 153, 156, 159 from ONO sub-system 110 prior to initiating shutdown of ONO sub-system 110, thereby preventing erroneous data from ONO sub-system 110 from being stored in AON sub-system 160.

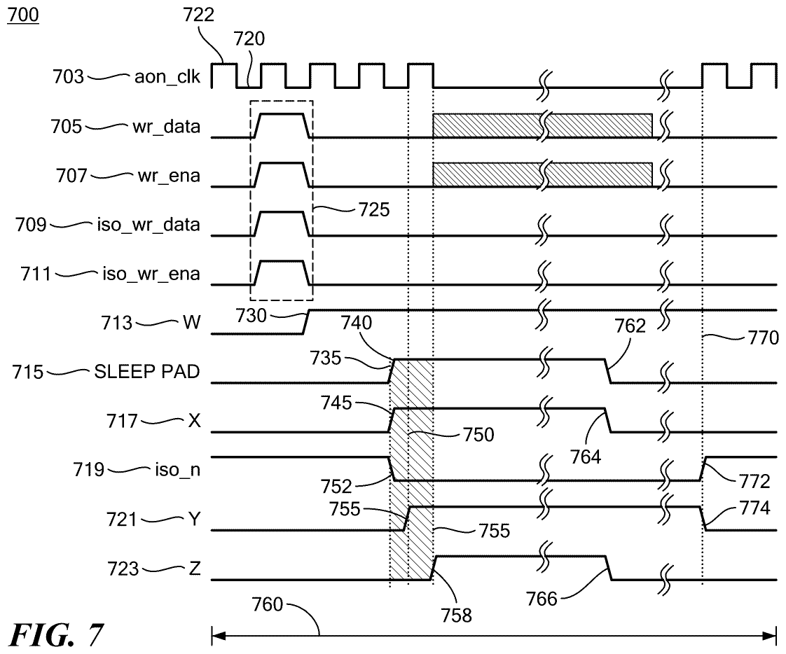

FIG. 7 shows a diagram 700 of example waveforms (e.g., waveforms 703, 705, 707, 709, 711, 713, 715, 717, 719, 721, 723) illustrating the operation (and/or configuration) of the example system of FIG. 6 in further detail. An X-axis 760 for each of the waveforms represents time, and a Y-axis (perpendicular to the X-axis) for each of the waveforms represents a voltage level.

703 is an example waveform of a voltage of signal 629 (aon_clk) of AON sub-system 160. As shown in FIG. 7, when ONO sub-system 110 is powered on, has reset properly, and is active, its clock signal may be received by AON sub-system 160, such that AON sub-system 160 has a clock signal 629 (aon_clk) that oscillates between logic-high (e.g., “1”) 722 and logic-low (e.g., “0”) 720 values at a certain frequency.

707 is an example waveform of a voltage of signal 156 (write enable (wr_ena)) and 711 is an example waveform of a voltage of signal 628 (isolated write enable (iso_wr_ena)), which is the write enable signal after it has passed through isolation AND gate 622. 705 is an example waveform of a voltage of signal 153 (write data (wr_data)) and 709 is an example waveform of a voltage of signal 626 (isolated write data (iso_wr_data)), which is the data to be written to storing circuitry 170 of AON sub-system 160 after passing through isolation AND gate 620. In the example of FIGS. 6 and 7, when signal 711 is at logic-level high (e.g., “1”) (meaning write is enabled and the inputs from the ONO sub-system 110 are not isolated from AON sub-system 160, data from ONO sub-system 110 may be programmed into storing circuitry 170 of AON sub-system 160 via signal 626 (iso_wr_data) (assuming reset of storing circuitry 170 has been released). That is, when the value of signal 626 (iso_wr_data) is a logic-low level (e.g., “0”), the logic-low level (e.g., “0”) may be stored in storing circuitry 170. When the value of signal 626 (iso_wr_data) is a logic-high level (e.g., “1”), the logic-high level (e.g., “1”) may be stored in storing circuitry 170. In the example shown in FIG. 7, all of signals 156, 153, 626, and 628 transition from a logic-low level (e.g., “0”) to a logic-high level (e.g., “1”) at a time 725.

713 is an example waveform of a voltage of signal 632 (“W”), which is output from output port Q of storing circuitry 170. As shown in FIG. 7, with signal 628 (iso_wr_ena) and signal 626 (iso_wr_data) both having been at a logic-high level (e.g., “1”) at a rising edge of signal 629 (aon_clk), signal 632 (“W”) out of output port Q of storing circuitry 170 may transition from a logic-low level (e.g., “0”) to a logic-high level (e.g., “1”) at a time 730. That is, a logic-high level (e.g., “1”) may have now been stored in storing circuitry 170.

715 is an example waveform of a voltage of signal 185 from sleep pad 180 (via optional I/O buffer 615). FIG. 7 shows an example where a power state command (a logic-high level (e.g., “1”)) is received from sleep pad 180 on signal 185. Signal 185 begins to transition from logic-low (e.g., “0”) to logic-high (e.g., “1”) at time 735 and finishes that transition at time 740.

717 is an example waveform of a voltage of signal 636 (“X”). Signal 636 (“X”) may be output from AND gate 634, which receives signal 632 (“W”) and signal 185 from sleep pad 180. As a result, the output (signal 636 (“X”)) of AND gate 634 may be asynchronous (not dependent on signal 629 (aon_clk)). Thus, as shown in FIG. 7, signal 636 (“X”) may transition from a logic-low level (e.g., “0”) to a logic-high level (e.g., “1”) at a time 745 that is substantially the same as the time signal 185 from sleep pad 180 transitions from a logic-low level (e.g., “0”) to a logic-high level (e.g., “1”). As shown in FIG. 7, time 745 may be before the next rising edge of signal 629 (aon_clk), which occurs at time 750.

719 is an example waveform of a voltage of signal 639 (iso_n). As shown in FIG. 7, when signal 636 (“X”) transitions from a logic-low level (e.g., “0”) to a logic-high level (e.g., “1”), NOR gate 638 may transition signal 639 from a logic-high level (e.g., “1”) to a logic-low level (e.g., “0”). As a result, the output (signal 639 (iso_n)) of NOR gate 638 may also be asynchronous (not dependent on signal 629 (aon_clk)). Thus, as shown in FIG. 7, signal 639 (iso_n) may transition from a logic-high level (e.g., “1”) to a logic-low level (e.g., “0”) at a time 752 that is substantially the same as time 185 when sleep pad 180 transitions from a logic-low level (e.g., “0”) to a logic-high level (e.g., “1”). As shown in FIG. 7, time 752 may be before the next rising edge of signal 629 (aon_clk), which occurs at time 750.

721 is an example waveform of a voltage of signal 642 (“Y”). As shown in FIG. 7, signal 642 (“Y”) may transition from a logic-low level (e.g., “0”) to a logic-high level (e.g., “1”) at the first rising edge of signal 629 (aon_clk) after signal 636 (“X”) transitions from a logic low-level (e.g., “0”) to a logic-high level (e.g., “1”).

723 is an example waveform of a voltage of signal 647 (“Z”). As shown in FIG. 7, signal 647 (“Z”) may transition from a logic-low level (e.g., “0”) to a logic-high level (e.g., “1”) at the first falling edge of signal 629 (aon_clk) after signal 642 (“Y”) transitions from a logic-low level (e.g., “0”) to a logic-high level (e.g., “1”), assuming signal 185 from sleep pad 180 is still at a logic-high level (e.g., “1”).

In the example of FIG. 7, signal 185 from sleep pad 180 transitions from its logic-high level (e.g., “1”) to a logic-low level (e.g., “0”) at time 762. As shown in FIG. 6, this transition may cause voltage regulator 130 to begin providing a voltage supply to ONO sub-system 110 again, thereby powering up ONO sub-system 110. As shown by waveform 717, signal 636 (“X”) may transition from its logic-high level (e.g., “1”) to a logic-low level (e.g., “0”) at time 764, which is substantially the same time as time 762 when signal 185 transitions from its logic-high level (e.g., “1”) to its logic-low level (e.g., “1”). As shown by waveform 723, signal 647 (“Z”) may transition from its logic-high level (e.g., “1”) to a logic-low level (e.g., “0”) at time 766, which is substantially the same time that signal 185 from sleep pad 180 transitions from its logic-high level (e.g., “1”) to its logic-low level (e.g., “0”). With signal 647 (“Z”) at a logic-low level (e.g., “0”), isolation AND gate 624 may allow the clock signal from ONO sub-system 110 to be provided to AON sub-system 160 when ONO sub-system 110 has properly reset and releases its clock signal to AON sub-system 160.

As shown in waveform 721, with signal 636 (“X”) at a logic-low level (e.g., “0”), storing circuitry 640 may output a logic-low level (e.g., “0”) on signal 642 (“Y”) on the first rising edge of signal 629 (aon_clk) when the clock is released by ONO sub-system 110 and again received by AON sub-system 160 (e.g., at a time 774). With signal 636 (“X”) and signal 642 (“Y”) at logic-low levels (e.g., 0s), NOR gate 638 may output a logic-high level (e.g., “1”) as signal 639 (iso_n) (e.g., at a time 772), thereby allowing signal 156 (wr_ena) to pass through isolation AND gate 622 and allowing signal 153 (wr_data) to pass through isolation AND gate 620. That is, once ONO sub-system 110 has properly reset and released its clock signal to AON sub-system 160, signal 156 (wr_ena) and signal(s) 153 (wr_data) may again be released to AON sub-system 160, such that ONO sub-system 110 may again program storing circuitry 170 with power mode configuration information.

Thus, as discussed above, in response to receiving a power state command (e.g., logic-high level (e.g., “1”)) on signal 185 from sleep pad 180, if the power mode configuration information stored in storing circuitry 170 determines that ONO sub-system 110 should be shut down (e.g., for a sleep mode), system 600 may isolate AON sub-system 160 from the signals (e.g., signals 153, 156, 159) from ONO sub-system 110 before ONO sub-system 110 is shut down, to prevent erroneous data from being stored in storing circuitry 170. Additionally, system 600 may allow AON sub-system 160 to remove the isolation from ONO sub-system 110 when the power state command is no longer received (e.g., when signal 185 from sleep pad 180 transitions back to a logic-low level (e.g., “0”)). As shown in FIG. 7 and as previously described, the isolation may be removed and the signals (e.g., signals 153, 156, 159) may again be received by AON sub-system 160 despite not having an active clock signal in AON sub-system 160 when the power state command is no longer received. That is, as shown in FIG. 7, signal 647 (“Z”) may transition to a logic-low level (e.g., “0”) when the power state command is no longer received, even though no clock is active in AON sub-system 160 at this time. Signal 647 may be input to isolation gate 624, and when signal 647 is again at a logic-low level (e.g., “0”), the clock signal from ONO sub-system 110 may be released by isolation AND gate 624 to AON sub-system 160, such that AON isolation AND gates 620, 622 may enable data such as power mode configuration information to be received from ONO sub-system and stored (e.g., programmed) into storing circuitry 170.

As discussed above, signal 647 (“Z”) may transition from a logic-high level (e.g., “1”) to a logic-low level (e.g., “0”) at substantially the same time as signal 185 from sleep pad 180 transitions from a logic-high level (e.g., “1” to a logic-low level (e.g., “0”) without needing any signal from a clock. Signal 647 (“Z”) may then enable isolation AND gate 624 to release the clock signal when it is again received from ONO sub-system 110 as signal 629 (aon_clk). As a result, the circuit loop 649 shown in FIG. 6 may be referred to as an asynchronous combinational loop, in that it allows the overall system to re-enter a normal active state from a state in which ONO sub-system 110 is inactive (e.g., a sleep mode) without requiring a clock to be active in AON sub-system 160.

Although specific example digital circuits were described above with respect to FIGS. 3 and 6, the disclosure should not be limited to these examples. A person of ordinary skill in the art would recognize that other combinations of known digital and/or analog components may be used to achieve the functions provided by the example circuits above. Such other combinations of known digital and/or analog components should be considered to be within the scope of the disclosure herein, so long as they perform substantially the same function in substantially the same way to obtain the same result.

Although specific timing diagrams were provided in FIGS. 5 and 7, it should be appreciated that these timing diagrams are examples, and were provided to further demonstrate the operation and/or configuration of the systems and methods described herein. A person of ordinary skill in the art would recognize that the signals, signal transitions, and timing shown in these example diagrams may vary depending on the signaling, signal timing, and particular implementation of the systems described herein.

Although certain signal states, such as logic-high (e.g., “1”) levels and logic-low (e.g., “0”) levels, are discussed above with respect to certain example signals and certain example times, the disclosure is not so limited. A person of ordinary skill in the art would recognize that similar functionality as that described above may be achieved using logic-low (e.g., “0”) values where logic-high (e.g., “1”) values have been described, and vice versa, by changing the components, connections between the components, and/or signaling of the circuitry discussed above.

Although systems are described above as including certain components, the disclosure herein should not be limited to these specific combinations of components. For example, in some embodiments, an ONO sub-system 110 and AON sub-system 160 may operate at the same voltage, in which case level shifter and/or isolation circuitry 140 and/or voltage regulator 130 may be unnecessary. Moreover, in some embodiments, one or more of buffers 610, 615 may be unnecessary. In some embodiments, additional components not described herein may be used in combination with components described herein to achieve perform substantially the same function in substantially the same way to achieve the same result. All of these variations should be considered to be within the scope of the disclosure herein.

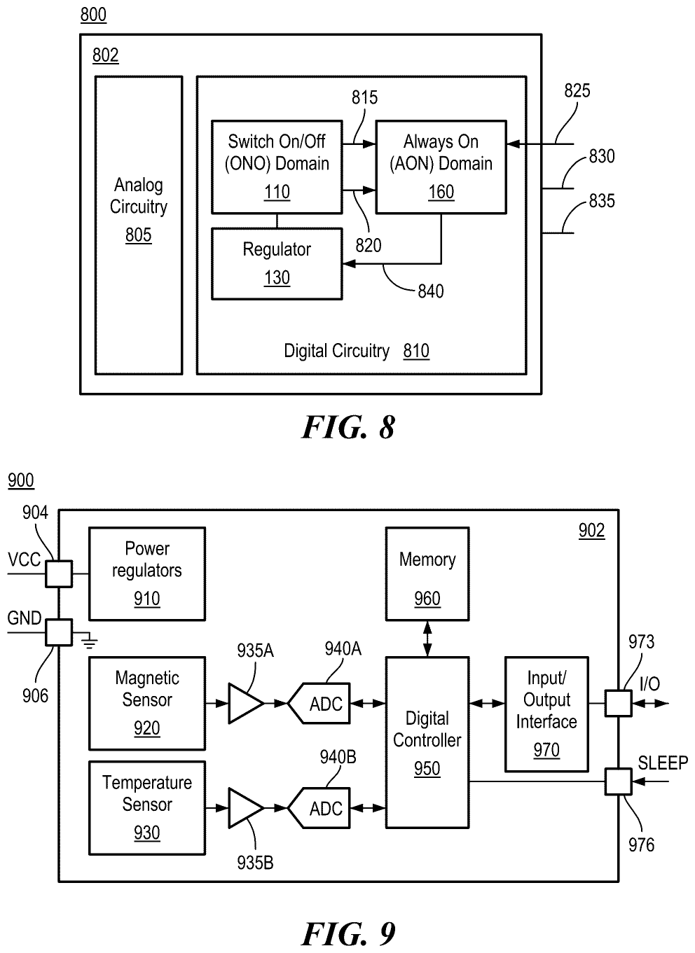

FIG. 8 shows a diagram 800 of a further example system 802 for power management, consistent with embodiments of the present disclosure. For example, system 802 may be a larger system that incorporates previously-discussed system 100, system 300, and/or system 600.

As shown in FIG. 8, system 802 may include digital circuity 810. Digital circuitry 810 may include an ONO sub-system 110 and an AON sub-system 160, as previously discussed. Data write and/or enable signals 815 may be provided from ONO sub-system 110 to AON sub-system 160, such that ONO sub-system 110 may program AON sub-system 160 with information, such as power mode configuration information. ONO sub-system 110 may also provide a clock signal 820 to AON sub-system 160, when ONO sub-system 110 is active and has been properly reset. As previously discussed, ONO sub-system 110 and AON sub-system 160 may operate at different voltages, and so a voltage regulator 130 may be used to convert a voltage to another voltage suitable for powering ONO sub-system 110. For example system 802 may receive a voltage (e.g., VCC) at an input terminal 830 and a ground reference voltage at another input terminal 835. In some embodiments, this voltage may be used to power AON sub-system 160, but may be converted to another voltage by voltage regulator 130 for powering ONO sub-system 110. Although voltage regulator 130 is shown as being part of digital circuitry 810, it may instead consist of analog circuitry 805, or of a combination of digital and analog circuitry. As shown in FIG. 8 and as previously discussed, AON sub-system may receive a power state command 825 from an integrated circuit or other component external to system 802. If AON sub-system 160 determines, based on power state command 825 and power mode configuration information stored in AON sub-system 160, that ONO sub-system 110 should be powered down, AON sub-system 160 may send a signal 840 to voltage regulator 130, which may then power down (e.g., remove the power supply to) ONO sub-system 110.

In some embodiments, system 802 may be a system in a larger system. For example, system 802 may be useful in a portable, battery-powered device where power saving modes would be useful in extending the battery life of the device. System 802 may include additional circuitry, such as analog circuitry 805. In some embodiments, ONO sub-system 110 may control analog circuitry 805 to perform one or more functions. For example, analog circuitry 805 may include one or more sensing elements, such as magnetic field sensing elements. When system 802 is operating in a normal, active power mode, ONO sub-system 110 may control analog circuitry 805 to obtain measurements from the one or more sensing elements in analog circuitry 805. When system 802 is operating in a low power mode, such as a sleep mode where measurements from the one or more sensing elements are not required, a power state command may be sent to AON sub-system 160, and AON sub-system 160 may power down ONO sub-system 110, so as to save battery power. In some embodiments, additional power modes may be provided. For example, a power mode may be provided that consumes less power than a normal, active mode, but more power than a sleep mode. Such a power mode may, for example, cause a clock frequency in ONO sub-system 110 to be reduced, such that ONO sub-system 110 obtains measurements from the one or more sensor elements less frequently than it would in a normal, active mode. In some embodiments, ONO sub-system 110 may program any number of different power modes into AON sub-system 160, such that AON sub-system 160 is able to control ONO sub-system 110 to achieve the desired power mode in response to a received power state command 825.

In some embodiments, system 802 may be implemented as an integrated circuit with analog circuitry, digital circuitry, and different voltage domains. In some embodiments, digital circuitry 810 may be provided as an integrated circuit with different voltage domains, and analog circuitry 805 may be provided as a separate integrated circuit or as one or more additional discrete components. In some embodiments, the circuitry of system 802 may be provided as discrete components. A person of ordinary skill in the art would recognize that there are many different combinations of integrated and/or discrete components that may be used to implement system 802, and the disclosure herein should be considered to encompass these different combinations.

FIG. 9 shows a diagram 900 of a still further example system 902 for power management, consistent with embodiments of the present disclosure. System 902 may be the same as system 802, but with some additional and/or different details shown. As shown in FIG. 9, system 902 may include a controller 950 (e.g., digital controller). Controller 950 may include an ONO sub-system 110 and an AON sub-system 160, as previously discussed. Controller 950 may include digital and/or analog circuitry. Controller 950 may include any suitable type of processing circuitry, such as an application-specific integrated circuit (ASIC), a field programmable gate array (FPGA), a coordinate rotation digital computer (CORDIC) processor, a special-purpose processor, synchronous digital logic, asynchronous digital logic, a general-purpose computer (e.g., MIPS processor, x86 processor), etc. In some embodiments, controller 950 may execute instructions stored in a memory 960.

Memory 960 may include any suitable type of volatile and/or non-volatile memory. In some embodiments the memory may be a non-transitory computer-readable medium. By way of example, memory 960 may include a random-access memory (RAM), a dynamic random-access memory (DRAM), an electrically-erasable programmable read-only memory (EEPROM), and/or any other suitable type of memory. The memory may store instructions that, when executed by controller 950, cause controller 950 to carry out certain determinations, steps, processes, comparisons, algorithms, and/or calculations.

System 902 may include power regulator(s) 910. Power regulator(s) may, for example, receive voltage (e.g., from VCC pin 904) and convert or regulate the voltage to provide a stable power supply to the various components of system 902. The various components of system 902 may also be coupled to a ground reference potential through pin 906.

System 902 may also include an input/output interface 970. An input/output interface 970 may be any suitable type of interface for receiving and/or sensing a signal (e.g., through pin 973). Input/output interface 970 may include one or more of a wired or wireless interface. By way of example, input/output interface 970 may include one or more current modulators for sending or receiving information along a conductor via current pulses, one or more voltage modulators for sending or receiving information along a conductor via voltage pulses, an Inter-Integrated Circuit (I2C) interface, a Controller Area Network (CAN) bus interface, a WiFi interface, an Ethernet interface, a Universal Serial Bus (USB) interface, a local area network (LAN) interface, a cellular (e.g., 5G) interface, and/or any other suitable type of interface.

System 902 may also include additional circuitry (e.g., analog circuitry), such as circuitry for a magnetic sensor 920 and/or a temperature sensor 930. Signals from these sensors may be processed and/or conditioned before being sent to digital controller 950. For example, FIG. 9 shows system 902 as including an amplifier 935A for amplifying a signal received from magnetic sensor 920, and an analog-to-digital converter (ADC) 940A for converting that amplified signal to a digital signal before sending the digital signal to digital controller 950. Similarly, FIG. 9 shows system 902 as including an amplifier 935B for amplifying a signal received from temperature sensor 930, and an ADC 940B for converting that amplified signal to a digital signal before sensing the digital signal to digital controller 950.

Controller 950 may also receive a power state command signal. For example, an AON sub-system 160 of controller 950 may receive a power state command signal from another circuit or component through a terminal 976 (shown as a “SLEEP” signal in FIG. 9). AON sub-system 160 of controller 950 may then act on that signal based on power mode configuration information stored in AON sub-system 160.

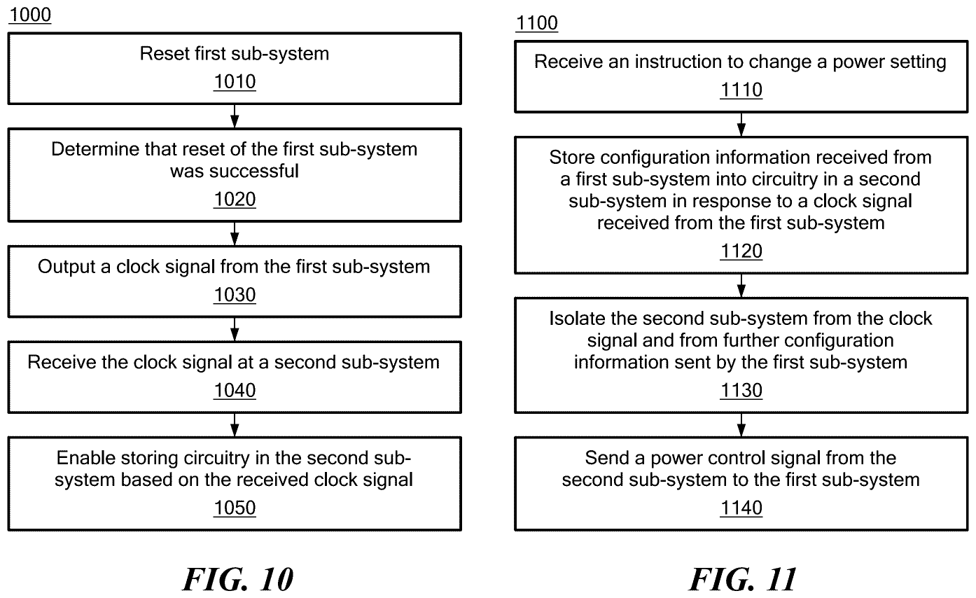

FIG. 10 shows an example process 1000 for ensuring that a first sub-system (e.g., ONO sub-system 110) has been successfully reset before enabling the storing of configuration information from the first sub-system in a second sub-system (e.g., AON sub-system 160), consistent with embodiments of the present disclosure. Process 1000 may be performed, for example, in a system, such as system 100, system 300, system 600, system 802, or system 902. In some embodiments, process 1000 may be performed in a controller, such as in controller 950 of system 902. Process 1000 may be performed, for example, to determine that an ONO sub-system 110 has been properly reset before allowing an AON sub-system 160 to store data sent to AON sub-system 160 from ONO sub-system 110.

In 1010, a first sub-system may be reset. The first sub-system may be an ONO sub-system 110, for example. Reset of ONO sub-system 110 may occur, for example, in response to a powering on of ONO sub-system 110, such as when powering on an entire system (including ONO sub-system 110), or in response to powering on ONO sub-system 110 when the system transitions from a low power mode (e.g., sleep state) to a mode in which ONO sub-system 110 is active (e.g., a normal, active mode of the system).

As previously discussed, resetting ONO sub-system 110 may involve determining, by reset generator circuitry (e.g., reset generator circuitry 120) that a stable voltage is being provided to ONO sub-system 110, releasing a set state (e.g., by reset generator circuitry 120) of one or more flip flops in reset release synchronizer circuitry (e.g., reset release synchronizer circuitry 320), and releasing a reset state of components within ONO sub-system 110 (e.g., by signal 340 from reset release synchronizer circuitry 320).

In 1020, a determination may be made that the reset of the first sub-system was successful. For example, a reset monitor (e.g., reset monitor 350) may determine whether values output from one or more flip flops within the reset monitor match pre-determined values. If they do not match the pre-determined values, the reset monitor may determine that ONO sub-system 110 has not been successfully reset. If they do match the pre-determined values, the reset monitor may determine that ONO sub-system 110 has been successfully reset.

In 1030, a clock signal may be output from the first sub-system. For example, a clock signal (e.g., signal 335 (ono_clk)) may be released from ONO sub-system 110, such that a second sub-system such as AON sub-system 160 may use the clock signal as signal 159 (aon_clk) and/or signal 629 (aon_clk). In some embodiments, as previously discussed, the clock signal may be output from ONO sub-system 110 in response to the reset monitor (e.g., reset monitor 350) outputting a signal 355 (e.g., reset_done) at a predetermined value, such as a logic-high level (e.g., “1”). If reset of the components in ONO sub-system 110 has been released (e.g., signal 340 (aon_2_rst) is at a logic-low level (e.g., “0”)) and signal 355 is at the predetermined value, then an AND gate 360 may output a signal 363 (aon_clk_ena) to an integrated clock gating circuitry 365, which includes a flip-flop 364 and an AND gate 367. Flip-flop 364 may receive signal 363 (aon_clk_ena) at its input D port, and may output the value of signal 363 as signal 366 at its output Q port on the next falling edge of signal 335 (ono_clk) (assuming signal 340 (ono_2_rst) is at a logic-low (e.g., “0”) level). An AND gate 367 may receive signal 366 at an input port, and may receive signal 335 (ono_clk) at another input port. When signal 366 is at a predetermined value, such as a logic-high level (e.g., “1”), AND gate 367 may output the clock signal from ONO sub-system 110 as signal 149.

In 1040, the clock signal may be received at a second sub-system. For example, the second sub-system may be an AON sub-system 160. As previously discussed, AON sub-system 160 may operate at a different voltage than ONO sub-system 110. As a result, a voltage range of the clock signal (signal 149) output from ONO sub-system 110 may be shifted by level shifter and/or isolation circuitry (e.g., level shifter and/or isolation circuitry 140), and the clock signal may be received by AON sub-system 160 as signal 159 (aon_clk). As further discussed, signal 159 may further pass through an isolation AND gate (e.g., isolation AND gate 624) and be received by AON sub-system 160 as signal 629 (aon_clk).

In 1050. storing circuitry within the second sub-system may be enabled based on the received clock signal. For example, storing circuitry 170 of AON sub-system 160) may be enabled based on the clock signal (e.g., signal 159 (aon_clk), signal 629 (aon_clk)). As previously discussed, when the clock signal is received from ONO sub-system 110, reset release synchronizer circuitry 370 in AON sub-system 160 may release a reset state of components within AON sub-system 160. This may occur, for example, by transitioning a signal (e.g., signal 380 (aon_2_rst) from a logic-high level (e.g., “1”) to a logic-low level (e.g., “0”), thereby releasing a release state of storing circuitry 170. Storing circuitry 170 may then store data received from ONO sub-system 110, such as power mode configuration information received over signal(s) 315.

As has also been previously discussed, in some embodiments, when the clock signal is received by AON sub-system 160, a signal 642 (“Y”) may be transitioned from one level, such as a logic-high level (e.g., “1”) to another level, such as a logic-low level (e.g., “0”). This may allow signals from ONO sub-system 110 to pass through isolation circuitry (e.g., isolation AND gates 620, 622), such as by outputting a predetermined value, such as a logic-high level (e.g., “1”) from a NOR gate 638 to the isolation circuitry. The signals from ONO sub-system 110 may then be used to store information, such as power mode configuration information, in storing circuitry 170 of AON sub-system 160.

FIG. 11 shows an example process 1100 for isolating a second sub-system (e.g., AON sub-system 160) from a first sub-system (e.g., ONO sub-system 110) prior to powering down the first sub-system, consistent with embodiments of the present disclosure. Process 1100 may be performed, for example, in a system, such as system 100, system 300, system 600, system 802, or system 902. In some embodiments, process 1100 may be performed in a controller, such as in controller 950 of system 902. Process 1100 may be performed, for example, to isolate an AON sub-system (e.g., AON sub-system 160) from an ONO sub-system (e.g., ONO sub-system 110), so as to prevent any erroneous data from being stored in the AON sub-system when the ONO sub-system is being powered down.

In 1110, an instruction to change a power setting may be received. For example, a power setting command may be received on a signal (e.g., signal 185) from a sleep pad (e.g., sleep pad 180) in a second sub-system (e.g., AON sub-system 160). The power setting command may, for example, by a logic-high level (e.g., “1”) on the signal. Storing circuitry 170 in AON sub-system 160 may store power mode configuration information. The power mode configuration information may indicate, for example, that the second sub-system should cause a first sub-system (e.g., ONO sub-system 110) to be powered down upon receipt of the power setting command.

If the second sub-system determines that the first sub-system should be powered down in response to the power state command, in 1120 the second sub-system may store the latest data received from the first sub-system to make sure the latest data has been stored. For example, the second sub-system may store the latest power mode configuration information in its storing circuitry 170 and/or in storing circuitry 640. Storing circuitry 170 and/or storing circuitry 640 may be driven by a clock signal (e.g., signal 159 (aon_clk), signal 629 (aon_clk)) based on a clock signal (e.g., signal 335 (ono_clk)) of the first sub-system, such that the power mode configuration information is stored in response to the clock signal.

In 1130, the second sub-system may be isolated from signals sent from the first sub-system. For example, the second sub-system (e.g., AON sub-system 160) may be isolated from the signals (e.g., signals 153, 156, 159) from the first sub-system (e.g., ONO sub-system 110) in preparation for powering down the first sub-system, so as to prevent any erroneous data from the first sub-system from being stored in the second sub-system. As previously discussed with respect to FIGS. 6 and 7, isolating the second sub-system from the first sub-system may involve circuitry (e.g., digital logic circuitry) causing isolation circuitry (e.g., isolation AND gates 620, 622, 624) to prevent signals (e.g., signals 153, 156, 159) from the first sub-system from being passed into the second sub-system.

In 1140, a power control signal may be sent from the second sub-system to the first sub-system. For example, after the second sub-system (e.g., AON sub-system 160) has been isolated from the signals from the first sub-system (e.g., ONO sub-system 110), the second sub-system may send a signal (e.g., signal 647 (“Z”)) of a predetermined value, such as a logic-high value (e.g., “1”), to a voltage regulator (e.g., voltage regulator 130) of the first sub-system. In response to the value on the signal, the voltage regulator may power down the first sub-system.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can contain internal processors or modules that perform portions of the function, operation, or sequence of operations. Similarly, a module can contain internal processors or internal modules that perform portions of the function, operation, or sequence of operations of the module.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

Various embodiments of the systems and methods are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same. Also, as used herein, “and/or” means “and” or “or,” as well as “and” and “or.” Moreover, all patent and non-patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

It should be recognized that values described herein may be exact or approximate. One of ordinary skill in the art would recognize that values described herein may vary depending on, for example, manufacturing tolerances of components in sensor devices. As a result, values that deviate from a described value by up to +/−20% of the described value may be deemed to correspond to the value described.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described with reference to one embodiment, knowledge of one skilled in the art may be relied upon to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A system, comprising:
a first sub-system comprising
a clock generator circuit,
a reset monitor circuit, and
a gate circuit configured to output a clock signal generated by the clock generator circuit when the reset monitor circuit determines that the first sub-system has successfully reset; and
a second sub-system comprising storing circuitry, wherein the storing circuitry is enabled to store configuration information received from the first sub-system in response to receiving the clock signal from the first sub-system.

2. The system of claim 1, wherein the first sub-system comprises a first voltage domain comprising a first set of circuit components configured to operate at a first voltage and the second sub-system comprises a second voltage domain comprising a second set of circuit components configured to operate at a second voltage different than the first voltage.

3. The system of claim 1, wherein
power to the first sub-system is configured to be switched on or off depending on a power mode, and
the second sub-system is configured to receive power so long as the system receives power.

4. The system of claim 1, wherein the first sub-system does not release the clock signal for output to the second sub-system until the reset monitor circuit determines that the first sub-system has successfully reset.

5. The system of claim 1, wherein the reset monitor circuit comprises:
a plurality of flip flops that are configured to receive a reset signal and to assume a respective default state when the reset signal is set to a predetermined value; and
a logic gate coupled to respective output ports of the flip flops and that outputs a signal indicating whether the assumed default state of each of the respective flip flops corresponds to an expected default state for each of the respective flip flops.

6. The system of claim 5, wherein the reset monitor circuit outputs a signal indicating that reset of the first sub-system is successful when the assumed default state of each of the respective flip flops corresponds to the expected default state for each of the respective flip flops.

7. The system of claim 1, wherein the gate circuit is configured to only output the clock signal to the second sub-system when an output from the reset monitor circuit indicates that reset of the first sub-system has been successful.

8. The system of claim 1, wherein the storing circuitry in the second sub-system is only enabled to store configuration information received from the first sub-system when the storing circuitry receives the clock signal from the first sub-system.

9. The system of claim 1, wherein the second sub-system manages the first sub-system and is programmed by the configuration information received from the first sub-system.

10. The system of claim 1, wherein the reset monitor and the gate circuit of the first sub-system prevent processing of invalid configuration information sent by the first sub-system when the first sub-system is being powered on from a power off state.

11. The system of claim 1, wherein the second sub-system relies on the clock signal from the first sub-system to store the configuration information from the first sub-system.

12. The system of claim 11, wherein the second sub-system does not have its own dedicated clock generator circuit.

13. The system of claim 1, wherein the storing circuitry of the second sub-system comprises one or more flip flops.

14. A method, comprising:
resetting a first sub-system;
outputting a clock signal from the first sub-system in response to determining that the resetting of the first sub-system was successful;
receiving the clock signal at a second sub-system; and
enabling storing circuitry in the second sub-system to store configuration information sent from the first sub-system in response to receiving the clock signal.

15. The method of claim 14, wherein resetting the first sub-system comprises resetting the circuitry of the first sub-system in response to powering on the first sub-system.

16. A system, comprising:
a first sub-system configured to output a clock signal; and
a second sub-system comprising
storing circuitry configured to
receive the clock signal, and
store configuration information received from the first sub-system in response to the clock signal, and
power mode circuitry configured to
receive an instruction to change a power setting, and
isolate the second sub-system from the clock signal and from further configuration information received from the first sub-system in response to the instruction.

17. The system of claim 16, wherein the first sub-system comprises a first voltage domain comprising a first set of circuit components configured to operate at a first voltage and the second sub-system comprises a second voltage domain comprising a second set of circuit components configured to operate at a second voltage different than the first voltage.

18. The system of claim 16, wherein power to the first sub-system is configured to be switched on or off depending on a power mode, and
the second sub-system is configured to receive power so long as the system receives power.

19. The system of claim 16, wherein the storing circuitry in the second sub-system is only enabled to store the configuration information received from the first sub-system when the storing circuitry receives the clock signal from the first sub-system.

20. The system of claim 16, wherein the second sub-system manages the first sub-system and is programmed by the configuration information received from the first sub-system.

21. The system of claim 16, wherein the second sub-system relies on the clock signal from the first sub-system to store the configuration information from the first sub-system.

22. The system of claim 16, wherein the second sub-system does not have its own dedicated clock generator circuit.

23. The system of claim 16, wherein the storing circuitry of the second sub-system comprises one or more flip flops.

24. The system of claim 16, wherein in response to the instruction to change the power setting, the power mode circuitry is configured to:
ensure the configuration information last received from the first sub-system is stored in the storing circuitry;
isolate further configuration information sent from the first sub-system to the second sub-system;
isolate the clock signal from the second sub-system; and
send a power control signal to the first sub-system.

25. The system of claim 16, wherein the instruction to change the power setting comprises an instruction to power down the first sub-system.

26. The system of claim 16, wherein the power mode circuitry of the second sub-system prevents processing of invalid configuration information sent by the first sub-system when the first sub-system is being powered off from a power on state.

27. A method, comprising:
receiving, by a second sub-system, an instruction to change a power setting;
storing, by the second sub-system, configuration information received from a first sub-system in response to the instruction and in response to a clock signal received from the first sub-system;
isolating the second sub-system from the clock signal and from further configuration information received from the first sub-system in response to the instruction; and
sending, by the second sub-system, a power control signal to the first sub-system.

28. The method of claim 27, wherein:
storing the configuration information received from the first sub-system in response to the instruction and in response to the clock signal ensures that the latest reliable configuration information sent from the first sub-system is stored in the second sub-system, and
isolating the second sub-system from the clock signal and from the further configuration information received from the first sub-system prevents the second sub-system from receiving an unreliable clock signal and unreliable further information from the first sub-system while the first sub-system powers down.
